(19) United States
(12) Patent Application Publication
(10) Pub. No.: US 2025/0312703 A1
(43) Pub. Date: Oct. 9, 2025

(54) MOTION SIMULATOR

(71) Applicant: Vortek LLC, White Plains, NY (US)

(72) Inventor: Michael Vito Greto, Trumbull, CT (US)

(73) Assignee: Vortek LLC, White Plains, NY (US)

(21) Appl. No.: 18/711,685

(22) PCT Filed: May 15, 2024
(86) PCT No.: PCT/US2024/029353

§ 371 Date: May 20, 2024

Related U.S. Application Data
(60) Provisional application No. 63/468,025, filed on May 22, 2023.

(51) Int. Cl. A63G 31/16; G09B 9/12

(52) U.S. Cl. CPC A63G 31/16; G09B 9/12

(57) ABSTRACT

A motion simulator including a first track, a second track, and a passenger cart having a compartment configured to receive a passenger and movable linearly along the first track. A counter cart is movable along the second track to counter to the passenger cart. The motion stimulator is lightweight, transportable and is self-supporting such that it is operational to spin the platform supporting the carts and move the carts linearly without being mounted to a supporting surface. Omni-directional wheels effect angular movement of the passenger compartment in multiple directions.

### BACKGROUND OF THE INVENTION

This application claims priority to provisional application Ser. No. 63/468,025, filed May 22, 2023, the entire contents of which are incorporated herein by reference.

### Field of the Invention

This application is directed to a motion simulator, and more particularly, to a motion simulator designed to generate and expose passengers to realistic sustained G-forces.

### Background

Current motion simulators used for flight simulation are quite expensive for a variety of reasons. First, due to their bulk, they are expensive and difficult to transport. Second, they lack stability and are not self-supporting and therefore need to be mounted or secured to a foundation such as the ground. Third, they require large amount of electricity to operate.

Additionally, current motion simulators do not always provide an effective virtual reality experience, are limited in usage and/or capabilities and are not properly controlled or suffer from other deficiencies.

### SUMMARY OF THE INVENTION

The present invention is directed to a motion simulator to provide a virtual reality simulation experience. The present invention is designed to generate and expose passengers to realistic dynamic omni-directional sustained G-forces. This is achieved in a lightweight, portable/transportable device that does not need to be mounted/secured to the ground or other strong foundation. Its design also enables less expensive transport and is less expensive to operate and reduces peak loads. This enables a larger number of simulators to be used at a given location, drawing from a single electrical source. Current simulators require large amounts of electrical energy, thereby limiting the number of simulators that can be used in a given location.

The advantages of the motion simulator devices of the present invention are achieved by its various inventive features including a) its balance of forces and/or mass and its counter-rotational forces; b) its base and spinning platform providing movement of the passenger along an arc in a full circular rotational movement; c) its flywheel in the base to cancel rotational forces to the base to provide stability to the entire device; and d) its omnidirectional wheels which avoid the need for a gyroscope. These advantages, as well as other advantages, are further achieved via the structure of the components of the device which are discussed in detail below.

The motion simulator, due to the aforementioned advantages, can be used for flight training in the commercial and defense industries as well as for entertainment/amusement. Its relatively low cost and transportable capabilities further enable such wide range of usage.

In accordance with one aspect of the present invention, a motion simulator is provided comprising a first track, a second track, a first cart having a compartment configured to receive a passenger and movable linearly along the first track and a second cart movable linearly along the second track, the second cart providing a counter to the first cart. The second cart can provide a counterforce to the first cart. The second cart can provide a counterbalance to a mass of the first cart.

In some embodiments, the first cart is pivotable about an axis transverse to a longitudinal axis of the first track. In some embodiments, the first cart comprises a first frame supporting a pod containing the compartment and the second cart comprises a second frame dimensioned to receive the first frame within the second frame. In some embodiments, a plurality of omnidirectional wheels are engageable with the pod to effect angular movement of the pod in one or more of left, right, upward and downward directions. In some embodiments, the omnidirectional wheels are in constant contact with an outer surface of a pod of the first cart to support opposing sides of the first cart to maintain stability of the pod during directional movement.

The second cart in some embodiments moves linearly in conjunction with linear movement of the first cart. In some embodiments, the first cart and second cart toward and away from each other is in a 1:1 relationship; in other more preferred embodiments, the first cart and second cart movement toward and away from each other is not in a 1:1 relationship such that the first cart moves a distance toward a center of the platform that differs from a distance the second cart moves toward a center of the platform.

In some embodiments, the first track is positioned inward of the second track.

In some embodiments, the motion simulator further comprises a platform which supports the first and second tracks and the first and second carts, the platform spinnable about a central axis to move the first cart along an arc in a full circular rotational movement. A base can be provided to support the platform, wherein the base includes a flywheel to cancel rotational forces to the base to provide stability to the motion simulator.

In some embodiments, the motion simulator is foldable for transport where for example the first and second tracks are foldable to provide compactness for transport. The first and second tracks can be configured so they are foldable when the second cart and first cart are moved from an outer position to a position closer to a center of motion simulator.

The motion simulator can provide a virtual reality experience for a passenger without a head mounted display worn by the passenger. A control can be provided in some embodiments positioned within the compartment, the control providing input to change a direction of the first cart. The control can further be configured to alter a display within the compartment.

In some embodiments, the first cart has a first set of roller bearings engageable with the first track for movement of the first cart along the first track and the second cart has a second set of roller bearings engageable with the second track for movement of the second cart along the second track.

In some embodiments, a first motor assembly and first pulley assembly effect linear movement of the first cart and a second motor assembly and second pulley assembly effect linear movement of the second cart. An additional motor assembly and pulley assembly for effecting linear movement of the first cart and an additional motor assembly and pulley assembly for effecting linear movement of the second cart can be provided in some embodiments.

In accordance with another aspect of the present invention, a motion simulator is provided comprising a base, a platform supported by the base, and a passenger cart supported by the platform. The first cart has a compartment configured to receive a passenger and is movable linearly along a first track. The platform is spinnable about a central axis to move the first cart along an arc in a full circular rotational movement and at least a first motor is actuable to move the passenger cart linearly, wherein the motion simulator is self-supporting such that it is operational to spin the platform and move the first cart linearly without being mounted to a supporting surface.

In some embodiments, the platform supports the first track.

In some embodiments, the first track is foldable for compactness for transport of the motion simulator.

In some embodiments, the base includes a flywheel to cancel rotational forces to the base to provide stability to the motion simulator.

In some embodiments, the motion simulator further includes a second cart movable linearly (axially) to counter linear (axial) movement of the first cart. In some embodiments, the platform supports a second track and the second cart is movable linearly along the second track, the first and second carts linearly movable toward and away from each other. The motion simulator can include a first motor assembly and first pulley assembly for effecting linear movement of the first cart and a second motor assembly and second pulley assembly for effecting linear movement of the second cart.

A plurality of omnidirectional wheels can be provided in some embodiments wherein the wheels are engageable with the pod to effect angular movement of the pod in one or more of left, right, upward and downward directions. In some embodiments, the omnidirectional wheels are in constant contact with an outer surface of a pod of the first cart to support opposing sides of the first cart to maintain stability of the pod during directional movement.

In accordance with another aspect of the present invention, a motion simulator is provided comprising a base, a platform supported by the base, and a passenger cart supported by the platform, the passenger cart having a compartment and the compartment configured to receive a passenger. The passenger cart is movable linearly along a first track and the platform is spinnable about a central axis to move the passenger cart along an arc in a full circular rotational movement. At least a first motor is actuable to move the passenger cart linearly wherein the motion simulator generates and exposes the passenger within the compartment of the passenger cart to realistic dynamic omni-direction sustained G-forces without the need of a gyroscope to change the direction of force.

In some embodiments, the motion simulator further includes a first motor assembly and first pulley assembly for effecting linear movement of the passenger cart and a second cart provides a counterforce to the passenger cart. A second motor assembly and second pulley assembly effect linear movement of the second cart toward and away from the passenger cart. Preferably, the passenger cart and second (counter) cart are movable independently from each other powered by different motor assemblies.

A plurality of omnidirectional wheels can be provided which are engageable with a pod of the passenger cart to effect angular movement of the pod in one or more of left, right, upward and downward directions. In some embodiments, the omnidirectional wheels are in constant contact with an outer surface of a pod of the passenger cart to support opposing sides of the cart to maintain stability of the pod during directional movement.

In some embodiments, the base includes a flywheel to cancel rotational forces to the base to provide stability to the motion simulator. In some embodiments, the flywheel generates electricity to spin the rotating platform.

In some embodiments, the motion provides a virtual reality experience for a passenger without a head mounted display worn by the passenger.

In some embodiments, a control is positioned within the compartment, the control providing input to change a direction of the passenger cart. In some embodiments, the control is configured to alter a display within the compartment.

In accordance with another aspect of the present invention, a motion simulator is provided comprising a base, a platform supported by the base, and a passenger cart supported by the platform. The passenger cart has a compartment configured to receive a passenger and is movable linearly along a first track, the platform spinnable about a central axis to move the cart along an arc in a full circular rotational movement. At least a first motor is actuable to move the passenger cart linearly. The base includes a flywheel to cancel rotational forces to the base to provide stability to the motion simulator.

In some embodiments, the flywheel generates electricity to spin the rotating platform.

In some embodiments, a roller bearing mount for supporting a plurality of side roller bearings and a plurality of upper roller bearings transverse to the side roller bearings. In some embodiments, a motor is positioned within an opening in the flywheel, and the flywheel and motor are mounted within the base. In some embodiments, the flywheel forces are applied directly to the base which is in contact with the ground.

In some embodiments, in use, the flywheel starts spinning prior to the rotating platform starting to spin, the flywheel spinning slowing when the platform starts spinning.

In some embodiments, a second cart provides a counterforce, and thus a counterbalance to the first cart, and a second motor assembly and second pulley assembly effect linear movement of the second cart toward and away from the first cart. In some embodiments, the first and second carts are movable independently from each other powered by different motor assemblies.

In accordance with another aspect of the present invention, a motion simulator is provided comprising a platform, a first track supported on the platform, a second track supported on the platform, a first cart having a compartment configured to receive a passenger and movable linearly along the first track and a second cart movable along the second track, wherein the first and second tracks are foldable to provide compactness for transport.

In some embodiments, the first and second tracks are foldable when the second cart and first cart are moved from an outer position to a position closer to a center of motion simulator. In some embodiments, the platform includes a first section, a second section and a third section between the first and second sections, wherein the first and second sections are hingedly connected to the third section.

### BRIEF DESCRIPTION OF THE DRAWINGS

So that those having ordinary skill in the art to which the subject invention appertains will more readily understand how to make and use the apparatus (device) disclosed herein, preferred embodiments thereof will be described in detail hereinbelow with reference to the drawings, wherein:

FIG. 1 is a perspective view of the motion simulator of the present invention showing the passenger cart and pulley (counter) cart in the outermost positions;

FIG. 2A is a perspective view of the motion simulator of FIG. 1 seen from an opposing side;

FIG. 2B is a bottom perspective view of the motion simulator of FIG. 1 showing the systems for moving the passenger and pulley carts;

FIG. 2C is a side view of the motion simulator of FIG. 1 with the arrows depicting directional movement (linear movement) of the passenger cart and pulley cart and showing adjustable distances between the centers of mass;

FIG. 3 is a side view similar to FIG. 2C showing axial movement of the passenger cart and pulley cart along the tracks wherein the carts are moved toward each other to a closer distance than in FIG. 2C;

FIG. 4A is a close-up view of a portion of the tracks for the passenger cart and counter cart;

FIG. 4B is a view similar to FIG. 2C showing additional components of the base (e.g., components of FIG. 31);

FIG. 4C is a close up view of the motor and pulley system for moving the passenger cart linearly along the passenger cart track;

FIG. 5 is a top view of the motion simulator of FIG. 1 showing the access door to the passenger cart in the open position and the passenger cart and counter cart in their outermost positions;

FIG. 6 is a top view similar to FIG. 5 with the access door in the closed position and showing arrows depicting rotational movement of the flywheel, arrows depicting rotational movement of the platform (and tracks), and arrows depicting axial (linear) movement of the passenger and counter carts;

FIG. 7 is a side view of the passenger cart of the motion simulator of FIG. 1;

FIG. 8 is a side view of the counter cart of the motion simulator of FIG. 1;

FIG. 9 is a side view of the rotating platform and the base of the motion simulator of FIG. 1:

FIG. 10 is a side view of the base of the motion simulator of FIG. 1 which supports the platform and rotating track;

FIG. 11A is an isometric view of the passenger cart of FIG. 1 showing the passenger pod positioned within the passenger cart frame;

FIG. 11B is a front view of the passenger cart of FIG. 11A;

FIG. 11C is an exploded view of the passenger cart and omnidirectional wheels of FIG. 11A;

FIG. 11D is an isometric view of the roller bearings of the passenger cart of FIG. 11A which move along the track to provide linear movement of the passenger cart;

FIG. 12 is a perspective view of the pod of the passenger cart of FIG. 11A showing the access door in the open position for entry into the pod;

FIG. 13 is an isometric view of the frame of the passenger cart of FIG. 11A;

FIG. 14 is a perspective view of the mount for the omnidirectional wheels for changing the direction of movement of the passenger pod of FIG. 11A;

FIG. 15A is a perspective view of the four omnidirectional wheels for changing the direction of movement of the passenger pod of FIG. 11A;

FIGS. 15B and 15C are close up views of one of the omnidirectional wheels of FIG. 15A, with FIG. 15B an exploded view with parts separated;

FIGS. 16A, 16B and 16C are side, isometric and top views, respectively, of the passenger pod of FIG. 12 (the frame is removed for clarity) with a passenger seated therein, and showing the omnidirectional wheel engagement of the pod;

FIGS. 17A-17F illustrate various orientations/directional positions of the passenger pod of FIG. 16A controlled by the omnidirectional wheels wherein:

FIG. 17A is a top view showing the straight (neutral position);

FIG. 17B is a top view showing a left turn;

FIG. 17C is a top view showing a right turn;

FIG. 17D is a side view showing the straight (neutral) position;

FIG. 17E is a side view showing a downward position; and

FIG. 17F is a side view showing an upward position;

FIG. 18A is a side view of the connection between the passenger cart and track of the motion simulator of FIG. 1;

FIG. 18B is a sectional view taken through line A-A of FIG. 18A;

FIG. 18C is a close up view of the area of detail B identified in FIG. 18B showing engagement of the bearings of the passenger cart with the passenger track of the platform of the device;

FIG. 19A is a side view of the connection between the counter cart and track of the motion simulator of FIG. 1;

FIG. 19B is a sectional view taken through line A-A of FIG. 19A;

FIG. 19C is a close up of the area of detail B identified in FIG. 19B showing engagement of the roller bearings of the counter cart with the counter cart track of the platform of the device;

FIG. 20 is a perspective view of the counter cart frame of FIG. 1 showing the opening for mounting the motor assemblies for the counter and passenger carts;

FIG. 21 is a perspective view of the counter cart frame showing the attached roller bearings, motor assembly and controllers;

FIG. 22 is a front view of the counter cart of FIG. 21;

FIG. 23 is a perspective view of the roller bearings of the counter cart of FIG. 21;

FIG. 24 is a perspective view of the counter cart and passenger cart pulley motors for moving the carts along their respective tracks;

FIG. 25 is a perspective view of the motor controllers for the passenger cart and the pulley cart;

FIG. 26A is a side view of the rotating platform (track) of FIG. 1, showing the central rotational axis of the platform;

FIG. 26B is a top view of the rotating platform of FIG. 1;

FIG. 27 is an exploded view showing the rotating platform and base of FIG. 1 with the flywheel and base roller bearings supported thereon;

FIG. 28 is a bottom perspective view of the rotating platform (track) and base of FIG. 1;

FIG. 29 is a top perspective view of the rotating platform and base of FIG. 1;

FIG. 30A is a side view of the rotating platform and base;

FIG. 30B is a sectional view taken along line C-C of FIG. 30A;

FIG. 31 is an exploded view of portions of the base and rotating platform rotation mechanism;

FIG. 32A is a perspective view of the assembled base, base roller bearings and flywheel of FIG. 31;

FIG. 33A is a side view of the base and base roller bearings of FIG. 32A;

FIG. 33B is a top view of the base, base roller bearings and flywheel of FIG. 33A;

FIG. 34 is a perspective view of the base roller bearings of the base of FIG. 32A;

FIG. 35 is a close up view of the area of detail E of FIG. 34 showing a close up view of the top and side bearings;

FIG. 36 is a side view of the motion simulator similar to FIG. 2C containing section line F-F;

FIG. 37A is a cross-sectional view taken along line F-F of FIG. 36;

FIG. 37B is an enlarged view of the area of detail G of FIG. 37A showing the passenger cart engagement with the track;

FIG. 38A is a side view of the base similar to FIG. 33A having section line H-H;

FIG. 38B is a cross-sectional view taken along line H-H of FIGS. 38A;

FIG. 38C is an enlarged view of the area of detail I of FIG. 38B;

FIGS. 39A-43 illustrate an alternate embodiment of the motion simulator of the present invention having a foldable track for transport, wherein:

FIG. 39A is a side view showing the track being moved to a folded position, the arrows depicting the folding movement of the track sections;

FIG. 39B is a side view showing the track in the fully folded position with the passenger cart within the pulley (counter) cart frame;

FIG. 40 is a side view of the track (platform) in the fully open position corresponding to the use position (the passenger and counter carts removed for clarity);

FIG. 41 is a side view similar to FIG. 40 showing the track in a partially folded position;

FIG. 42 is a side view similar to FIG. 41 showing the track in the fully folded position;

FIG. 43A is a side view similar to FIG. 41 containing the designated area of detail J; and

FIG. 43B is a close up view of the area of detail J identified in FIG. 41.

### DETAILED DESCRIPTION OF PREFERRED EMBODIMENTS

The present invention is directed to a motion simulator to provide a virtual reality simulation experience. The present invention is designed to generate and expose passengers to realistic dynamic omni-directional sustained G-forces. Current motion simulators are expensive and are limited in use since they are required to be mounted/secured to the ground or other strong foundation. Further, due to their size and weight (bulk), current motion simulators are difficult and expensive to transport. Additionally, current simulators require large amounts of electrical energy, thereby limiting the number of simulators that can be used in a given location.

The motion simulator devices of the present invention provide a unique approach for virtual reality simulation which enables the device to be self-supporting and need not be attached to the ground or other foundation. This is achieved through its balance of forces and/or mass and its counter-rotational forces as discussed in detail below. Additionally, due to its platform rotational features, it only draws low peak electrical loads from the electric grid. This not only reduces operational cost but enables multiple devices to be at the same location drawing from the same electrical source. Further, the dynamic omni-directional G-forces of the motion simulator device of the present invention are achieved without the need of a gyroscope to change the direction of force. This reduces the amount of torque in the device. Each of these features are discussed in detail below. It should be appreciated that the motion simulators of the present invention do not need to include all of the foregoing features, as each feature in and of itself provides distinct advantages over the prior art. Therefore, the motion simulator could have for example only one or only two of these features and still be advantageous and within the scope of the present invention.

The motion simulators of the present invention are also of reduced bulk to facilitate transport. In some embodiments, the motion simulator is more easily transportable since it is foldable to a compact configuration. This not only facilitates transport but storage as well. This foldability of the simulator, wherein the track portions are hingedly connected for folding, is discussed in detail below.

The motion simulator of the present invention (also referred to herein as the “simulator device” or “device,” i.e., these terms are used interchangeably), in general, can be considered to have four main components: 1) a passenger cart in which the passenger sits and has multiple viewing screens and can move axially (linearly) along a track as well as pivot; 2) a pulley cart (also referred to herein as a “counter cart”) which moves axially (linearly) along another track in conjunction with the axial (linear) movement of the passenger cart, but in an opposing direction to apply a counter balance/counterforce with respect to the mass of the passenger cart; 3) a platform which spins about a central axis to move the passenger cart (and counter cart) along an arc in a full circular rotational movement; and 4) a base which forms the foundation for the entire device and which contains a flywheel to cancel rotational forces to the base to provide stability to the entire device. The details and functions of each of these features are discussed below. The advantages of such features will also become apparent from the discussion below. In general, the foregoing features provide a system that due to its counterbalance and cancellation of forces can be self-supporting and does not to be fixed to the ground or other supporting surface/supporting platform. This is achieved by the unique structural features of the device disclosed in detail below and illustrated in the drawings. It should be appreciated that alternatively, the motion simulator can have fewer than all four components (#1-#4) and designed with only one, only two or only three of these components and still be advantageous and within the scope of the present invention.

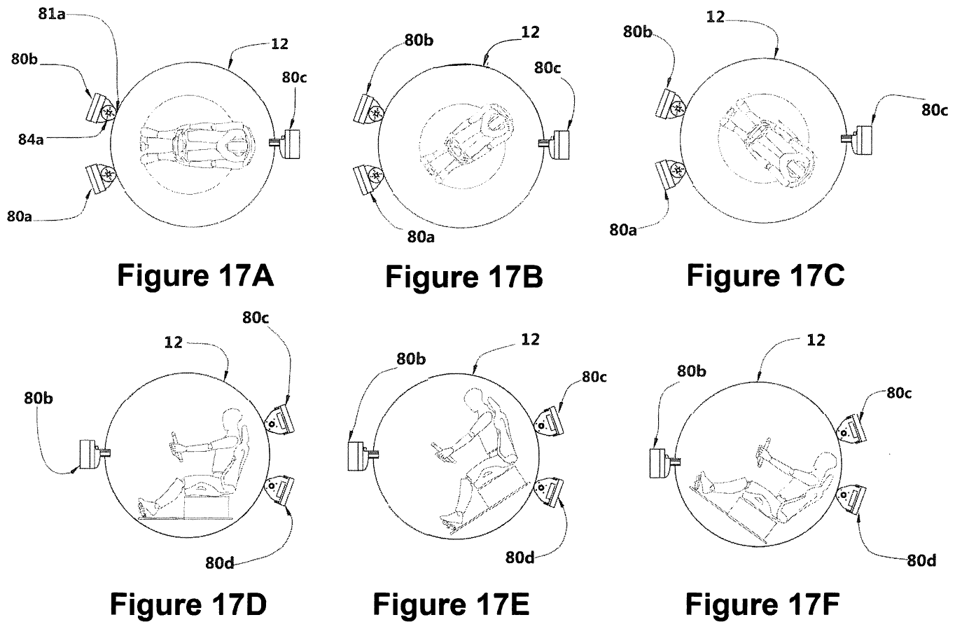

Note as used herein the term “upper” or “top” refers to the portion or region of the device further from the ground and the term “lower” or “bottom” refers to the portion or region of the device closer to the ground. The terms “device” and “apparatus” and “simulator” are used herein interchangeably. The terms “left” and “right” and “up” and “down” are in relation to the orientations shown in the drawings, e.g., FIG. 17B shows movement to left and FIG. 17C shows movement to the right.

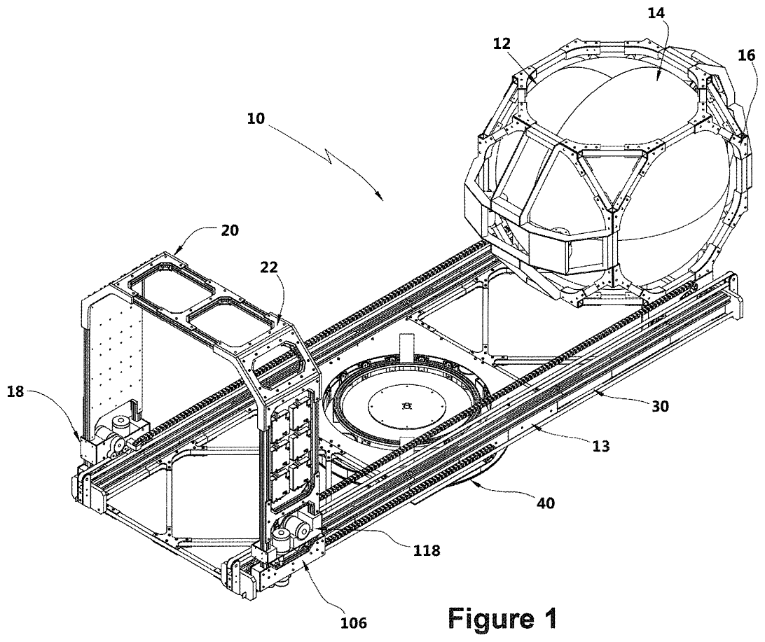

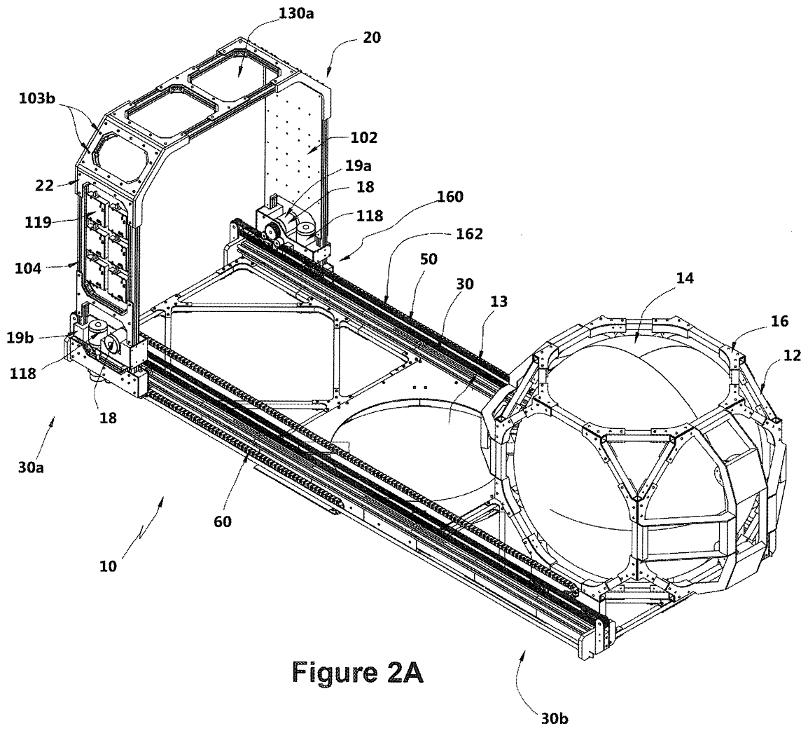

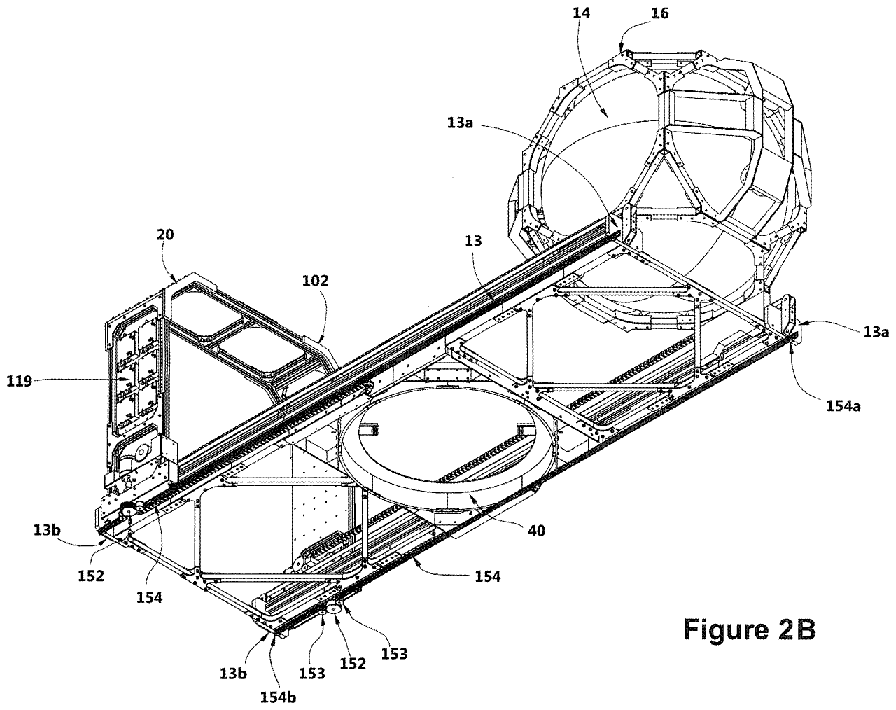

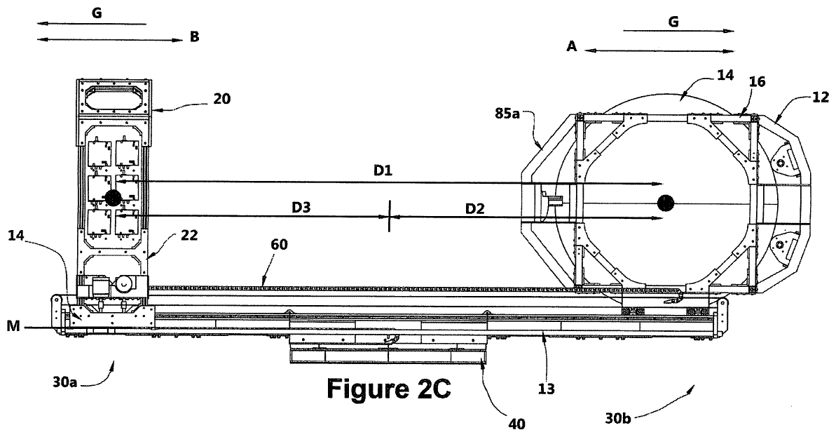

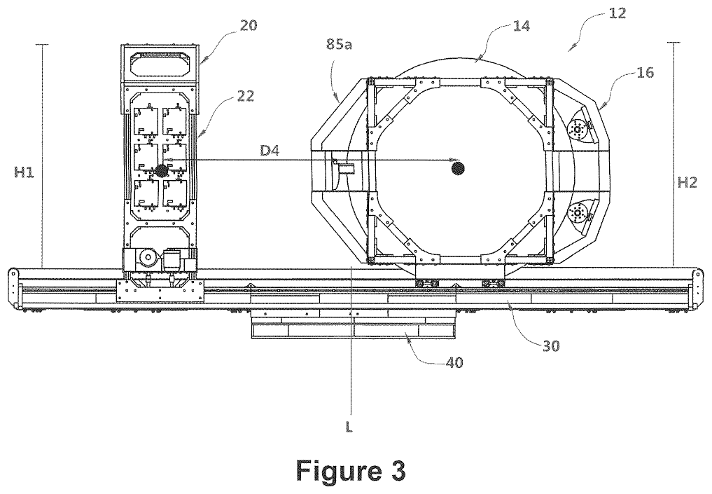

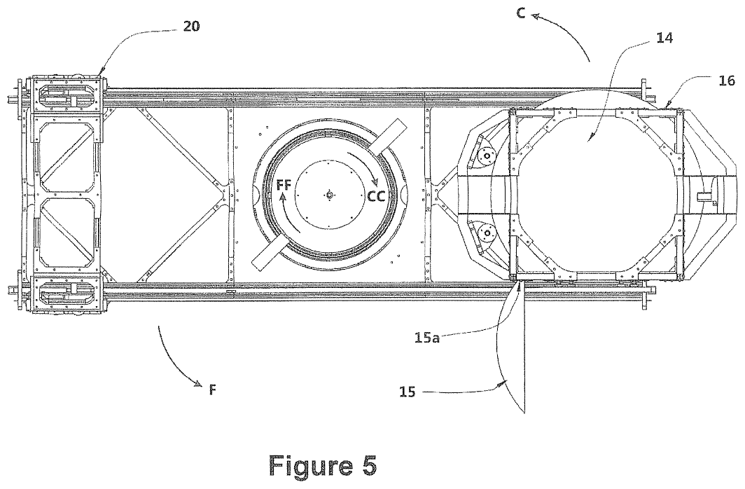

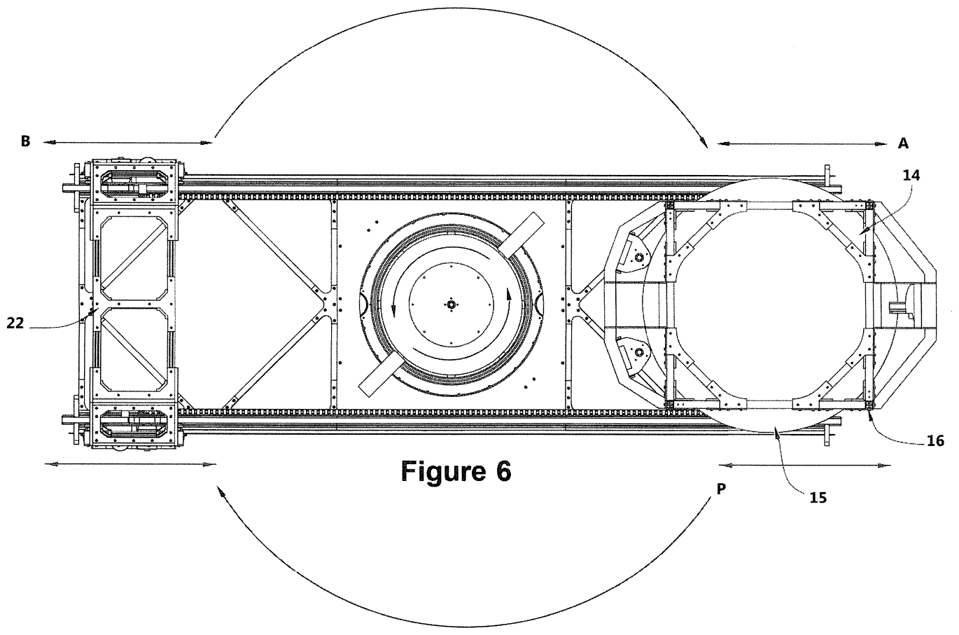

Referring now to the drawings and particular embodiments of the present disclosure, wherein like reference numerals identify similar structural features of the devices throughout the several views, the simulator device of a first embodiment of the present invention is designated generally by reference numeral 10. With initial reference to FIGS. 1-3 and 5, the device 10 comprises a passenger cart 12 which receives/carries/supports a passenger therein, an opposing pulley cart 20 (also referred to herein as counter cart 20), a rotating platform 13 on which the passenger cart 12 and pulley cart 20 are mounted and which support the tracks for the passenger cart 12 and pulley cart 14, and a base 40. The platform 13 spins about its central axis L (FIG. 3) which is perpendicular to a longitudinal axis M of the platform 13 (FIG. 2C). The spinning direction is depicted by arrow F in FIGS. 5 and 6. The pulley cart 20 moves along longitudinal axis M of the platform as depicted by arrow B of FIG. 2C, and the passenger cart 12 moves along the longitudinal axis M as depicted by arrow A of FIG. 2C. Various motors control the spinning and axial movement, as described in detail below. The pulley cart 20 is positioned at one end 30a of the platform 13 and the passenger cart 12 is positioned on the opposing end 30b of the platform 13 in the position of FIG. 1, which can be an initial (starting) position.

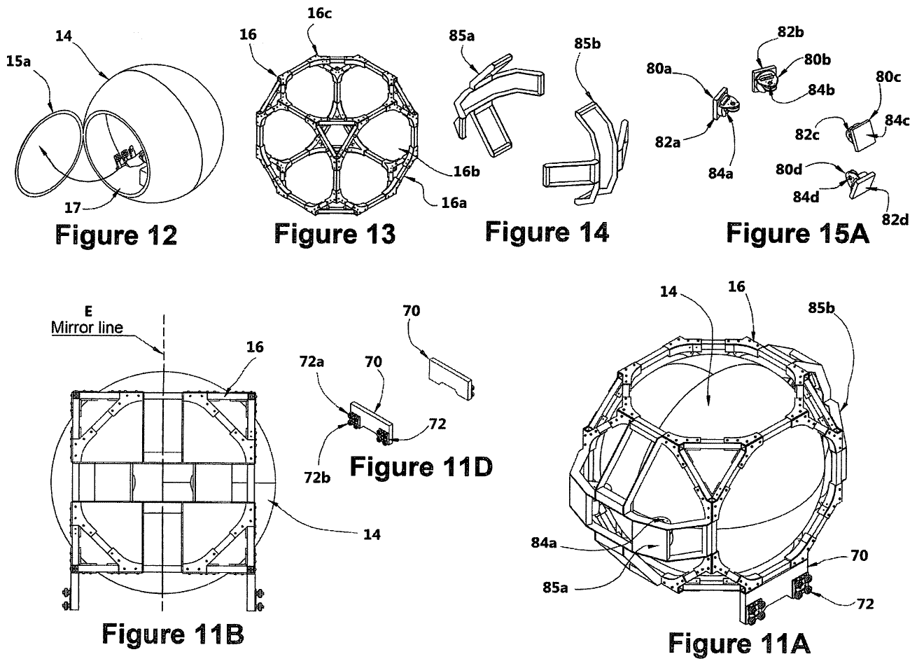

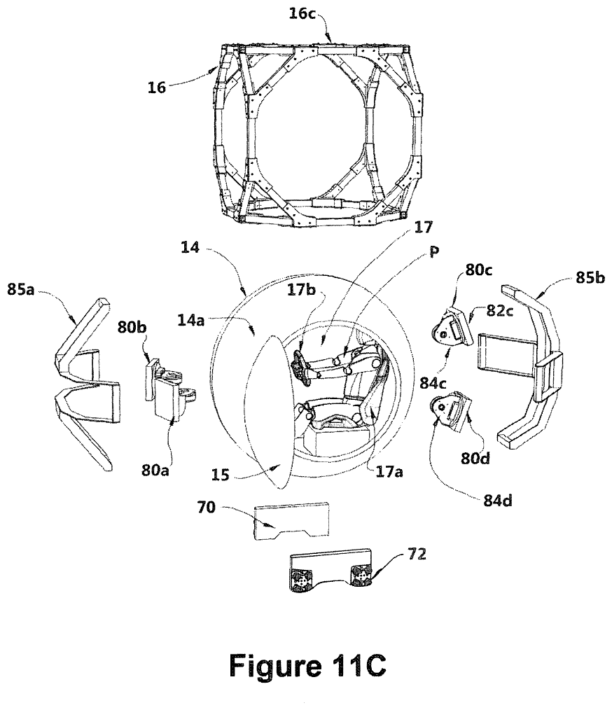

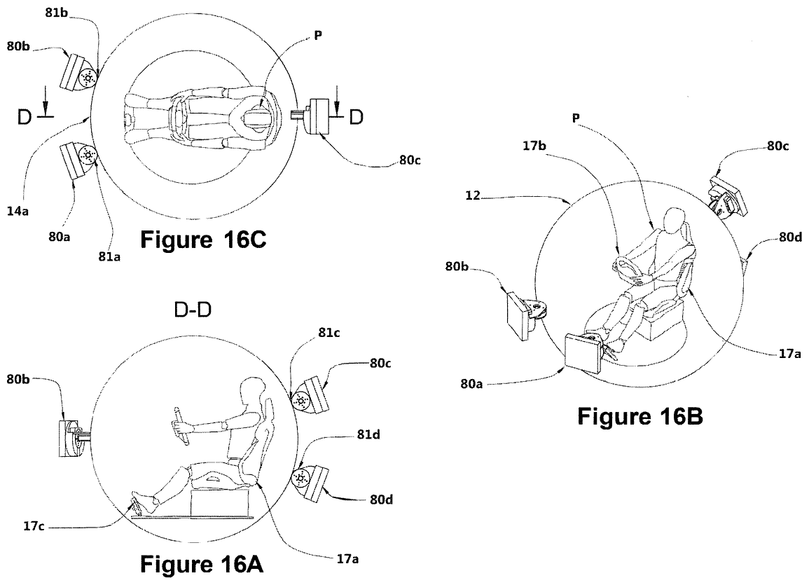

Turning first to passenger cart 12, the passenger cart 12 includes a pod 14 in which the passenger is seated and an outer frame 16. The pod 14, as shown for example in FIGS. 5 and 11C, is spherical in shape (although other shapes are also envisioned) and has a door 15 pivotable on hinge 15a from an open position as shown in FIG. 5 to allow passenger access to the inside compartment 17 to a closed position (see e.g., FIG. 6) for use of the device 10. The door can be a shape and size other than that shown and can be attached to the pod 14 by various methods of attachment and openable/closable in various ways. Within the compartment 17 is a seat 17a with a control 17b. The control 17b is shown in the form of a wheel but other controls, such as levers, switches, etc. can alternately be provided. The control 17b controls movement (pivoting) of the passenger pod 14 within the supporting frame 16. The control 17b can also control linear movement of the passenger cart 12 (pod 14 and frame 16) along the track of the platform 13. A foot pedal 17c (FIG. 16A) can be provided to provide operational functions, e.g., initiating linear movement of the passenger cart, stopping linear movement of the passenger cart 12, as well as provide for other passenger cart and/or pod movements. In other embodiments, the foot pedal can merely function as a foot rest for passenger comfort/positioning.

As explained in detail herein, there are two kinds of movement of the passenger cart: in one type of movement the entire passenger cart 12, which includes the frame 16, which carries the pod 14, is moved along the track of the platform; in another type of movement the frame 16 remains stationary and the pod 14 moves, e.g., pivots, within the stationary frame 16 to change its position (orientation) with respect to the underlying platform 13.

Within the compartment 17 of the passenger pod 14 are one or more screen (displays) which can depict various environments to provide the virtual reality experience. These displays can include images for flight simulators such as for aircraft or spacecraft, race cars, amusement rides such as roller coasters, etc. The display can in some embodiments be a concave display along the wall of the spherical cart. The display can be formed for example by one or more curved screens, a series of adjacent flat screens to form an arc, etc. The display(s) along with the sensors and feedback discussed below create a virtual reality experience.

In a preferred embodiment, the virtual reality is created without the need for a head mounted display to be worn by the passenger. This avoids cumbersome headgear and enhances the experience. However, it should be appreciated that in alternate embodiments, the system can be adapted for use with a wearable head mounted display such as glasses, goggles, headsets, helmets, visors, etc. These can be used for virtual and/or augmented reality.

Within the passenger pod 17, as mentioned above, is a passenger control 17b which provides passenger input to change the direction of the passenger cart 12. The control 17b can also be utilized to change the display or other settings. The passenger pod movement via control 17b is illustrated in FIGS. 17A-17F showing the up, down, left and right movement of the pod 14 (FIGS. 17F, 17E, 17B and 17C, respectively). The control 17b can also in some embodiments control forward and backward movement along the track. Thus, the passenger control 17b provides a passenger input and is in the form of a wheel, although other manual maneuverability devices can alternatively or in addition be utilized such as a throttle or lever. It is also contemplated that more than one manual control can be provided, with the multiple manual controls providing different functions/movements of the passenger pod 14. In alternate embodiments, instead of in the form of a mechanical control, the control can be in the form of an electrical device such as a button or switch activated by the passenger within the compartment 17. Alternatively, or in addition, voice command controls from within the passenger cart 12 activated by the passenger are also contemplated to provide the passenger input for movement or display selection and/or to provide other settings. Also envisioned are wireless, e.g., Bluetooth, controls or controls via brain wave sensors or brain-computer interfaces.

The passenger control 17b is provided within the passenger pod 14 in the embodiments where the passenger is in control of the movement. However, it is also envisioned, that the input can be controlled outside the passenger cart 12 so that another person or a computer generated control provides the movement input and other parameters for use of the device. Such external input/control can be in addition or in lieu of the input/control within the passenger pod activated by the passenger.

One or more sensors can be provided within the passenger cart 12. These sensors can be in communication with a computing device and can detect user interaction with the input control 17b. These sensors can include motion sensors to detect spinning, rotation, sliding, etc. The sensors can also include accelerometers, pressure sensors, vibration sensors, etc. Other types of sensors for measuring various parameters are also contemplated. An acoustic feedback device could also be included to provide the user with an auditory image, e.g., sound effects, music, etc.

Physical feedback is also contemplated wherein an electronically generated simulation of physical senses is provided which can include haptic feedback. Such physical feedback can include vibrations, sounds, visual alerts, etc.

The sensors can provide feedback of information regarding use of the device such as speed, number and degree of movements, maneuverability, intensity, duration, and other parameters associated with performed movements and motions. The information can be associated with movements of the device as well as actual movements of the passenger, e.g., passenger head movements during use. This information can be displayed to the passenger during use as well as displayed on a remote device to individuals monitoring use. The data can be stored and used by the passenger to inform later uses of the device. The data can also be collected and stored to provide the manufacturer or other individuals or third parties with information on use. Machine learning processes are also contemplated using the data to generate algorithms to produce outputs based on the data either during use or for subsequent uses.

The computing device can include a microcontroller, microprocessor, digital signal processor, etc. The computing device can be in communication with a remote device such as a mobile device, e.g., a smartphone. A network interface device may be utilized for connecting the computing device to one or more networks and one or more devices.

Sensor data can also be used by a control device to direct actions during use which can be especially useful when the device is used as an aircraft simulator.

Referring back to details of the passenger cart 12, and with reference to FIGS. 11A to 13C, frame 16 of passenger cart 12 has a series of struts 16a secured together by multiple bolts or rivets 16c into a substantially hexagonal shape having six sides, i.e., four sides and a top and bottom side. Each of the sides is formed by struts arranged in a substantially octagonal shape with an opening 16b between the struts. Other openings between the struts are also formed. These openings reduce the overall weight of the frame to aid in forming a lightweight design to facilitate transport as described herein. (Note for clarity, not all the struts and openings are labeled in the drawings). The openings 16b also accommodate the passenger pod 14 and allow for movement of the pod 14 within/with respect to the frame 16. The frame 16 also moves linearly along the track 30 of platform 13, thereby carrying pod 14 linearly along the track. As shown, the pod 14 extends partially within the openings 16b between the struts 16a, but alternatively could be more inward of the struts 16a or protrude outwardly of the struts 16a. The passenger pod 14 is therefore supported by the frame 16 for linear movement along the track while allowing directional change of the pod 14 relative to the frame 16. Note the passenger cart 12 is preferably symmetrical as represented by mirror line E of FIG. 11B. It should be appreciated that the frame can be of other shapes and configurations than the somewhat spherical shape shown to accommodate and support the pod 14 therein, as well as can be formed by a different number and/or size of struts or other support components. Thus, FIGS. 11A and 11C provide just one example of a frame and passenger pod/compartment that can be utilized.

Frame 16 also supports the wheels which control movement of the pod 14. More specifically, attached on opposing sides of the frame 16, at a lower portion thereof, i.e., a portion closer to the platform 13, is a roller bearing mount 70 containing two sets of roller bearings 72. These roller bearings 72 ride within the passenger cart track discussed in detail below to enable linear movement of the passenger cart 12 along the track. More specifically, the bearing mount 70 extends below the lower surface of the frame 16 so the roller bearings 72 are below the frame 16 to engage the passenger track. The passenger track, as explained below, has two longitudinally extending parallel tracks, one on each side of the platform 13. i.e., one on each side of the central longitudinal axis of the platform 13. In this manner, one set of bearings 72 on one side of the frame 16 engages one of the tracks and a second set of bearings 72 on the opposite side of the frame 16 engages the other track. Two pairs of four bearings 72 are shown, on each mount 70, although a different number of bearings are also contemplated to achieve the function. The roller bearing mounts 70 extend below the lower edge of the frame 12 to engage the track beneath the frame 12. A motor assembly and pulley system for effecting linear movement of the passenger cart 12 along the track is mounted on counter cart 20 and discussed below.

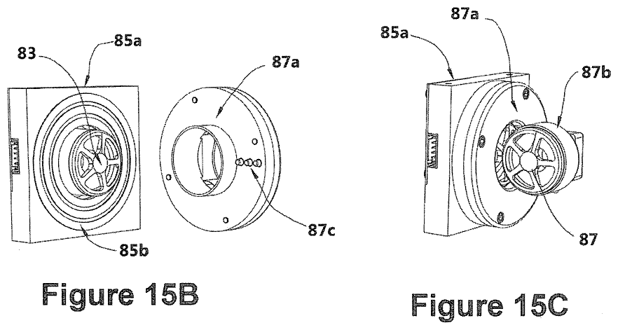

To change the direction of the G-force, a series of omnidirectional wheel assemblies 80a, 80b, 80c, and 80d (collectively referred to as omnidirectional wheel assemblies 80) are in contact with the outer surface 14a of the pod 14. The omnidirectional wheel assemblies 80a, 80b, 80c, and 80d, as shown in FIGS. 15A and 11C, include respective wheel bases 82a, 82b, 82c, 82d (collectively wheel bases 82) which support respective wheels 84a, 84b, 84c, 84d (collectively wheels 84). The wheels 84a, 84b, 84c and 84d are in contact with the outer surface 14a of pod 14 at respective contact areas 81a, 81b, 81c and 81d (FIGS. 16A and 16C). Thus, the pod 14 during movement is supported on opposing sides which better maintains stability during movement. That is, the pod 14 is rigidly mounted to the frame 12 as it is held in place by the omnidirectional wheels 84. The omni-directional G-forces of the simulator device of the present invention are achieved without the need of a gyroscope to change the direction of force. The provision of the omni-directional wheels reduces the amount of torque in the device.

Wheel mounts (supports) 85a and 85b (FIGS. 14 and 11C) are attached to opposing sides of the frame 16 so are positioned on opposite sides of the pod 14. As shown in FIG. 11A, the wheel mounts 85a, 85b are mounted to the outside of the frame 12 with the wheels 84 extending inwardly of the frame 16 to contact the pod 14. The wheel bases 82a and 82b are attached to wheel mount 85a and wheel bases 82c and 82d are attached to wheel mount 85b. In the illustrated embodiment, four omni-directional wheels are provided, however, it is also contemplated that a different number of wheels can be provided. The omnidirectional wheels 80, by positioned on opposing sides of the pod 14, and maintaining constant contact, help maintain the stability of the pod 14 during directional movement. With reference to FIGS. 15A and 15B, each of the wheel assemblies 80 has a first motor 83 mounted in motor frame 85a. A second motor 87 with motor tire 87b is mounted in motor frame 87a. Motor frame 85a has a brass rotating slip ring 85b engaging stationary slip ring brush 87c to transmit power to the wheels 84 to alter the direction of the wheels 14a to change the direction of pod 14 (and passenger P within the compartment 17 of the pod 14). Each motor 83, 87 can control different directional movements by controlling pivoting of the wheels in different directions. Motor 83 holds motor 87 and its components and functions to orient motor 87 to the correct angle when making contact with pod 14 to manipulate the pod 14. All four motors 87 need to be oriented correctly each frame of the PID loop to manipulate pod 14 orientation correctly.

G-force direction is produced by the movement of the pod 14 which is effected by control of the motor assembly containing motors 83 and 87. As shown in the drawings, the passenger pod 14 in a neutral or start position is aligned with the longitudinal axis with the passenger P facing the counter cart 20 and in line with the counter cart 20 as shown in FIG. 17A and 17D (see also FIGS. 16A-16C). The pod 14 can be pivoted downwardly (FIG. 17E), upwardly (FIG. 17F), to the left (FIG. 17B) and to the right (FIG. 17c). The extent of upward and downward and left and right movement can vary from that shown, e.g., can be at lesser or greater angles.

The passenger cart 12 can also be moved forward and backward along the track of the platform 13. Since the entire platform 13 is rotating about its central axis M, the closer the passenger cart 12 moves toward the central axis C, the faster it moves. Stated another way, the linear movement enables an adjustable radius and as the radius decreases, with the same speed maintained, there are greater forces. This linear movement, along with the counter linear movement of the counter cart 20, is discussed in detail below, along with the pulley system for moving the passenger cart 12.

Turning now to the counter (pulley) cart 20 of device 10, in general, the counter cart 20 is designed to provide a counter force to balance out the force of the passenger cart 12. More specifically, with reference to FIGS. 2A and 20-25, the counter cart 20 includes a frame 22 which in the illustrated embodiment is substantially arch or U-shaped with lateral sides 102, 104 joined by top wall (panel) 103. The frame portions can comprise a plurality of struts or other supports which can be attached by bolts 103b, rivets, other types of fasteners or by other methods. (For clarity, only a few of the frame fasteners are labeled in the drawings).

Frame side (side panel) 102 supports a motor assembly 19a and frame side (side panel) 104, opposite frame side 102, supports motor assembly 19b. Each motor assembly 19a, 19b includes a motor 18 for powering the passenger cart 12 and a motor 118 for powering the counter cart 20. More specifically, frame panel 102 has an opening 102a to receive the motor assembly 19a containing motors 18 and 118 and frame panel 104 has an opening 104a to receive the motor assembly 19b containing motors 18 and 118. Motor controller 119 for motors 18 and 118 is supported in side panel 104, above the motor assembly 19b; and a motor controller 121 for motors 18 and 118 is supported in side panel 102, above the motor assembly 19a. The motor controllers 119, 121 are in electrical communication with the respective motor assemblies 18, 118 to actuate the motors which activates the pulley systems to move the respective counter cart 20 and passenger cart 12 linearly along their tracks. As shown in FIG. 2A, the motor 18 is positioned perpendicular to the motor 118, with motor 18 extending laterally and motor 118 extending downwardly for engagement of the pulley systems described below.

Frame 22 supports two roller bearing mounts 106a, 106b (collectively roller bearing mounts 106) containing two sets of roller bearings 108. One bearing mount 106a is mounted to side panel 104 and the other bearing mount 106b is mounted to side panel 102. The bearings ride within the counter cart track discussed in detail below to enable linear movement of the counter cart 20 along the track. The bearing mounts 106 extend below the lower surface of the frame 22 so the roller bearings 108 are below the frame 22 to engage the counter cart track. The counter cart track, as explained below, has two parallel tracks, one on each side of the platform 13. In this manner one set of bearings 108 on one side of the frame 22 engages one of the tracks and a second set of bearings 108 on the opposite side of the frame 22 engages the other track. Two pairs of four bearings 108 are shown in each set, although a different number of bearings are also contemplated to achieve the function. A motor assembly and pulley system for effecting linear movement of the counter cart 20 along the track is mounted on counter cart 20 and discussed below. Note the passenger cart track and counter cart track are separate and run parallel to each other.

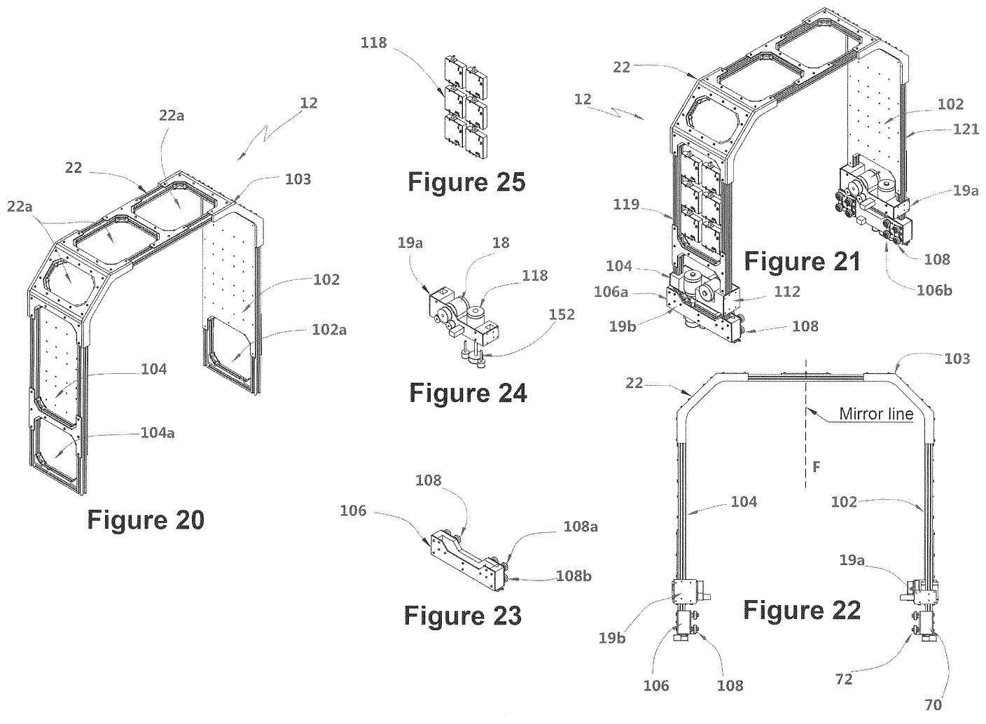

Frame 22 also has cutout areas, e.g., cutouts 22a to reduce the overall weight of the device 10 to facilitate transport as described herein. The cutouts can be formed in the frame panels themselves or can be created by attachment of the struts of the frame 22 creating openings (cutouts). Note the frame 22 is shown U or arch shaped, however other configurations are also possible. Additionally note that the frame 22 can be formed of multiple panels, struts, components, etc. that are fastened together into the desired shape, FIG. 20 providing only one example of such components and configuration.

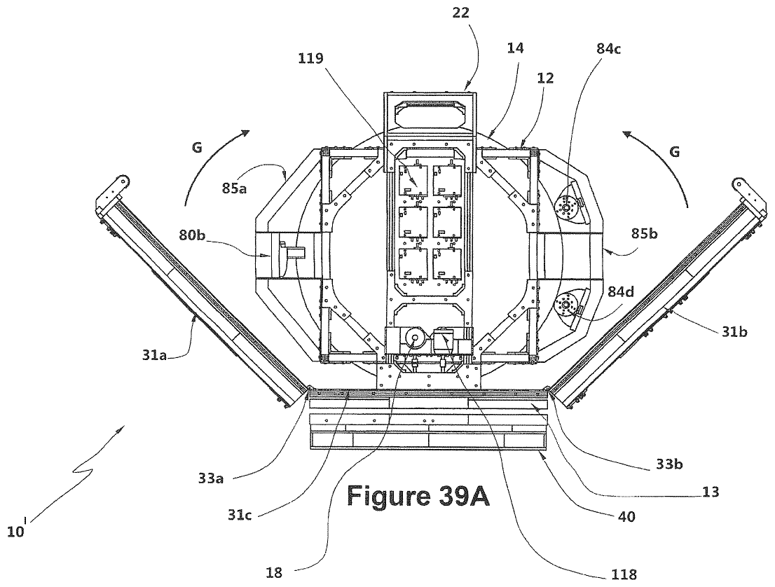

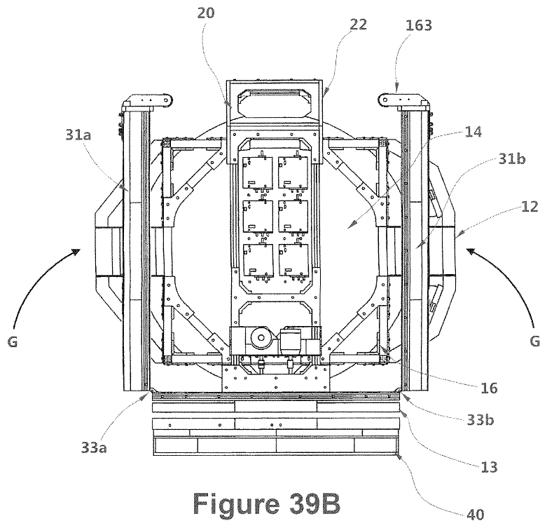

The counter cart frame 22 preferably has a height H1 (FIG. 3) which is greater than a height H2 of passenger cart 12. (The height is measured from the track to the top end of the cart). In this manner, upon full inward movement of the passenger cart 12, it can “fit” within the frame 22 of counter cart 20 to provide a more compact configuration, and easier to maneuver device for transport. This is especially useful in the embodiments of the device where the track is foldable into a more compact configuration for transport and/or storage as shown for example in FIG. 39B discussed in detail below.

Turning now to the movement of the passenger cart 12 and counter cart 20, the attachment to the tracks and the motor assembly and pulley system of the carts will now be described. Note the passenger cart 12 and counter cart 20 are designed to move in unison, i.e., they either move toward each other or away from each other. Note the distance moved however does not need to be in a 1:1 relationship, e.g., the passenger cart 12 can move along the track a greater distance toward the center of platform 13 than the pulley cart 20, or the pulley cart 20 can move along the track a greater distance toward the center of platform 13 than the passenger cart 12, as long as the movement is sufficient to provide the counterbalance/counterforce to the passenger cart 12 and maintain the stability of the system during rotational movement of the platform 13. However, it should be noted that both carts 12 and 20 move independently from each other to accommodate different passenger loads within the pod 14 of the passenger cart 12. The G-force is generated by the centrifugal force of the rotating tracks. The G-force can be calculated as mass×velocity/radius, with mass defined by the passenger cart and passenger. When spinning of both carts occurs due to rotation of the platform, the G forces cancel out (see G-force arrows of FIG. 2C). Both carts 12, 20 slide linearly on the linear tracks and move in sync for balance when the tracks (platform 13) rotate on the base 40.

FIGS. 2C and 3 show movement of the carts 12, 20. FIG. 2C illustrates the “furthest distance” or outermost position which in some uses can be considered the initial (neutral) or start position, although other linear positions of the carts 12, 20 could alternatively be the initial or start position. In this initial position, the center (or center point or center of mass) of passenger cart 12 is a distance D1 from the center (or center point) of counter cart 20; and a center (or center point) of passenger cart 12 is a distance D2 from the center/center line L of the platform 13; and a center (center point) of counter cart 20 is a distance D3 from the center/center line L of the platform 13. FIG. 3 illustrates a position wherein the carts 12 and 20 have moved along their respective tracks toward each other, with D4 depicting the distance between the center of counter cart 20 and center of passenger cart 12, wherein D4<D1. Note in this position, a portion of passenger frame 16 is over the center line C (mirror line) while counter frame 22 is a distance from the center line C. This illustrates how the movement of the carts 12, 20 is not necessarily in a one-to-one ratio. It should be appreciated that FIG. 3 shows an example of one of the positions of the carts 12, 20 relative to each other when the motors are activated to effect axial/linear movement along the track, it being understood that the carts can be moved along and stopped along the track at other distances and the ratio of movement of the two carts can be different than that illustrated. Thus, the distances between the centers of mass of the carts 12, 20 are adjustable.

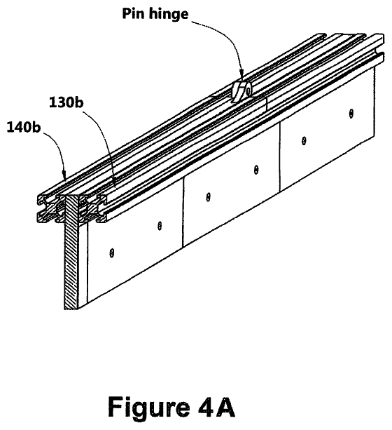

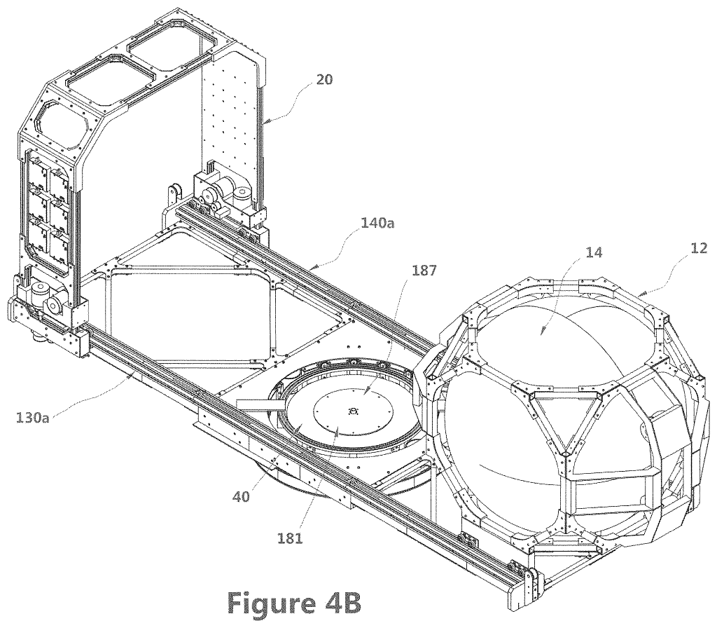

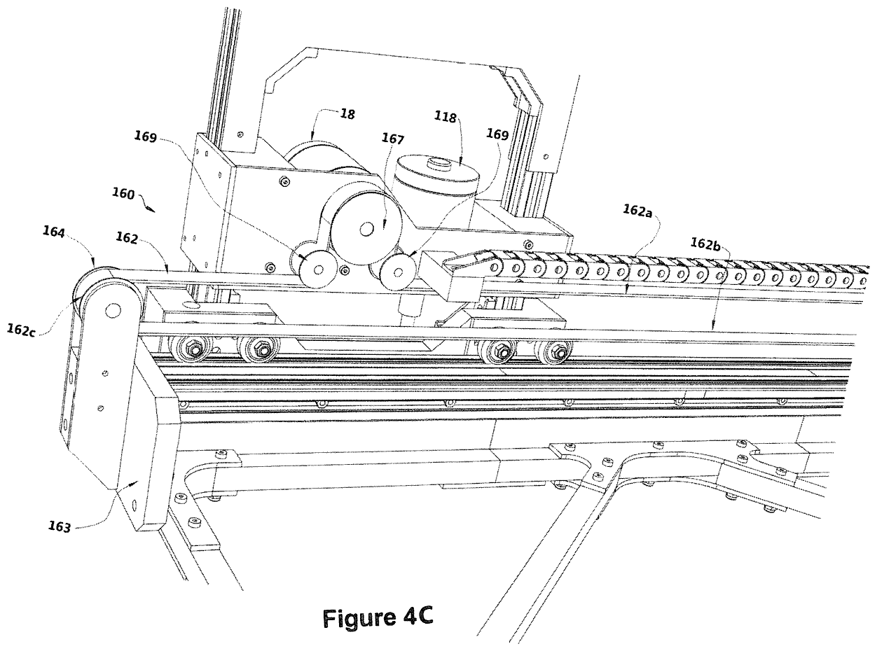

The platform tracks for the passenger and counter carts 12 and 20 are illustrated in the close up views of FIGS. 4A and 4B. The passenger track 130 has a left side passenger track 130a and a right side passenger track 130b, each on an opposing side of the central longitudinal axis of platform 13, and the counter track 140 has a left side counter track 140a and a right side counter track 140b, each on an opposing side of the central longitudinal axis of platform 13. In the illustrated embodiment, the left side track 130a is spaced radially inwardly of the left side track 140a and the left side track 130b is spaced radially inwardly of the left side track 140b. In this manner, the passenger track 130 forms an inner track for the passenger cart 12 and the counter track 140 forms an outer track for the counter cart 20. This movement along separate independent tracks enables the passenger cart 12 to “fit” within (under) the frame 22 of the counter cart 12 for transport and for foldability in the embodiments wherein the device/track is foldable. It should be appreciated that in alternate embodiments, the passenger track 130 can be outside the counter track 140. The track assembly of the device 10 is designed to be thin and lightweight which not only aids transport but results in needing less energy to spin the platform as compared to bulkier systems. It should be appreciated that the tracks 130 and 140 in preferred embodiments extend the length of the device to enable passenger cart 12 to advance linearly past the center of rotation. In such embodiments, the counter cart 20 can also extend pass the center of the device. It some embodiments, sufficient advancement can provide a braking force.

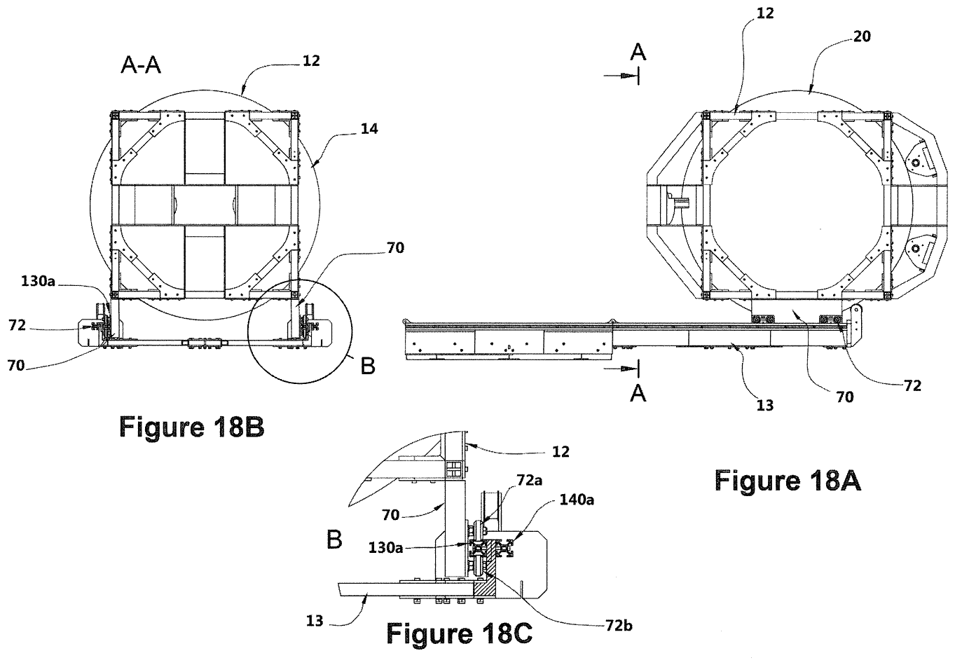

FIGS. 18A-18C illustrate the mounting of the passenger cart 12 within the passenger track 130 for linear travel thereon (therealong). As shown, the upper and lower roller bearings 72a, 72b engage the passenger track 130a. As can be appreciated by the drawings, passenger track 130a is positioned inward of counter track 140a. Note the bearing mount 70 is mounted to the frame 12 so the roller bearings 72 face outwardly of the frame 12 (away from the central longitudinal axis M of the platform 13) to engage the track 130. As the passenger cart 12 is moved along track 130a, the upper and lower roller bearings 72a, 72b travel within the track 130a. The roller bearings 72 on the opposite side of the frame 12 (FIG. 18B) engage the passenger track 130b in the same manner so the roller bearings 72 travel within the track 130b on the opposite side. Thus, the frame 12 is symmetrical with the bearing mounts 70 and roller bearings 72 identical on each side of frame 12.

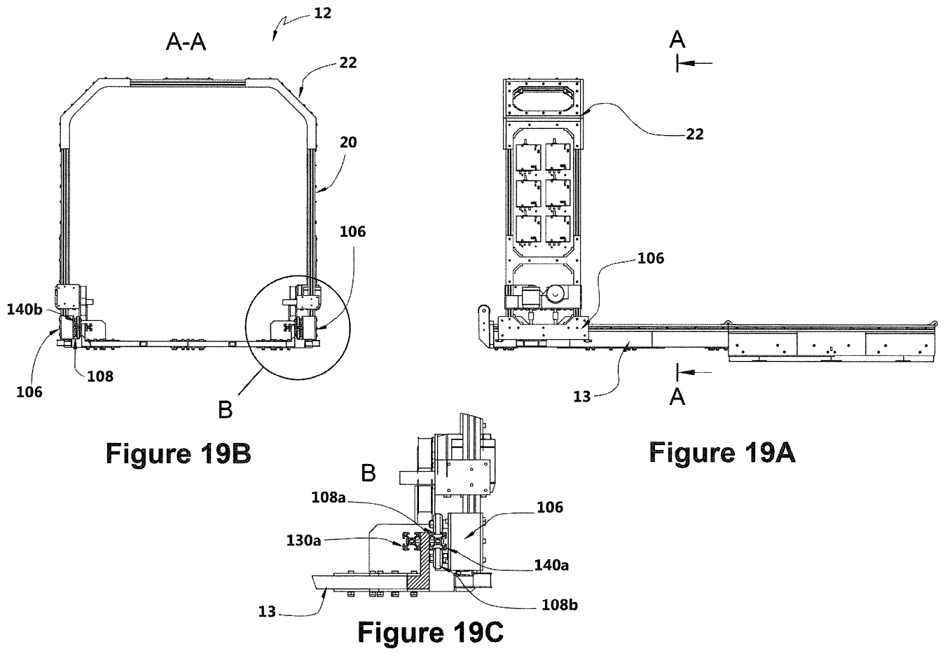

FIGS. 19A-19C illustrate the mounting of the counter cart 20 within the counter track 140. As shown, the upper and lower roller bearings 108a, 108b engage the counter track 140a. As can be appreciated by the drawings, counter track 140a is positioned outward of passenger track 130a. Note the bearing mount 106 is mounted to the frame 22 so the roller bearings 108 face inwardly (toward the central longitudinal axis M of the platform 13) to engage the track 140a. As the counter cart 20 is moved along track 140a, the upper and lower roller bearings 108a, 108b travel within the track 140a. The roller bearings 108 on the opposite side of the frame 22 (FIG. 19B) engage the passenger track 140b in the same manner so the roller bearings 108 travel within the counter track 140b on the opposite side. Thus, the frame 22 is symmetrical with the bearing mounts 106 and roller bearings 108 identical on each side of frame 22. As noted above, with the passenger track 130 and counter track 140 spaced apart, each of the carts 12, 20 can move independently along their individual tracks without interfering with the other cart.

Turning now to the motor assembly and pulley systems for the passenger cart 12 and counter cart 20 which effect movement of the carts 12, 20 within the respective tracks 130, 140, and with reference to FIGS. 2A, 2B and 4C, the motor assemblies 19a, 19b are supported in frame 20. The motor assembly 19a, containing motor 18 for powering the passenger cart 12 and motor 118 for powering the counter cart 20 is positioned in side panel 102 and the motor assembly 19b, containing motor 18 for powering the passenger cart 12 and motor 118 for powering the counter cart 118, is positioned in side panel 104. Thus, the passenger cart 12 is powered by two motors 18 and the counter cart 20 is powered by two motors 118. As shown, each motor 18 is positioned transverse to the motor 118. Motors 118 face in an upward-downward direction and motors 18 face in an inward-outward direction. Rotation of the motor shafts effect movement of a belt or gear/roller to move the respective cart 12, 20 linearly along the respective track 130, 140. Note the counter cart 20 is preferably symmetrical so that the motor assemblies 19a, 19b on the right and left side panels 102, 104 are preferably identical.

Turning first to the movement of the counter cart 20, and with reference to the bottom view of FIG. 2B, a track gear 152 is attached to the shaft of motor 118. Rollers 153 on opposing sides of the gear 152 maintain the belt or strap 154 around the gear 152. As motor shaft of motor 118 spins in a first direction, e.g., a clockwise direction, the track gear 152 slides along underneath track 140, moving along the fixed belt or strap 154 to advance the counter cart 20 along the track 140 toward the passenger cart 12. (The gear 152 extends downwardly from the motor assembly 19a, 19b to a position below the platform 13). To move the counter cart 20 backwards, i.e., away from the center of the platform 13 (and away from the passenger cart 12) toward the outer end of the platform 13, the direction of the motor 118 is reversed, e.g., spun counterclockwise, causing rotation of the motor shaft counterclockwise to move the track gear 152 in a backwards direction along the track toward the outer end of the platform 13. The belt 154 is fixed at end 154a and at an opposite end 154b to platform mounts 13a, 13b, respectively. This attachment is shown in FIG. 2B. The pulley system is preferably symmetrical so an identical pulley arrangement (belt 154, gear 152, etc.) is on the opposite side of the counter cart 12 as shown in FIG. 2B with the belt 154 on this opposite side fixed at opposite ends to mounts 13a, 13b.

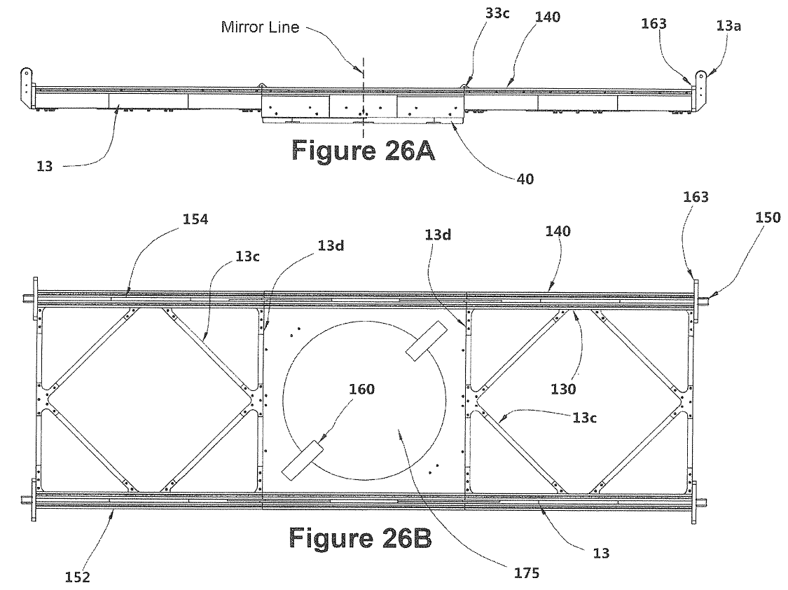

Movement of passenger cart 12 is effected by pulley system 160 shown in FIG. 2A and in the close up view of FIG. 4C. Belt 162 extends through notch 163 (FIG. 26A) to loop around idler pulley 164 to keep the belt 162 aligned. Another idler pulley 164 is positioned at the opposite end. The belt 162 forms a loop as it extends around idler pulleys 164 at opposite ends of the platform 13, thereby forming an upper belt portion 162a and a lower belt portion 162b. Gear/wheel assembly 167 is attached to the motor shaft 18a of motor 18. Rollers 169 help maintain the belt 162 wrapped around gear 167. As motor shaft 18 spins in a first direction, e.g., a clockwise direction, the belt 162 moves to advance the passenger cart 12 along the track 130. To move the passenger cart 20 backwards, i.e., away from the center of the platform 13, the direction of the motor is reversed, e.g., spun counterclockwise, causing rotation of the motor shaft counterclockwise to move the move the belt 164 in the reverse direction pulling the passenger cart backward toward the outer end of the platform 13. The pulley system is preferably symmetrical so an identical pulley arrangement (motor powered (by motor 18) belt 162, idler pulley 164, gear 167, etc.) is on the opposite side of the passenger cart 12. The symmetry of the passenger cart 12 and pulley cart 20 pulley systems helps to maintain the weight balance (equally distributed weight) of the system.

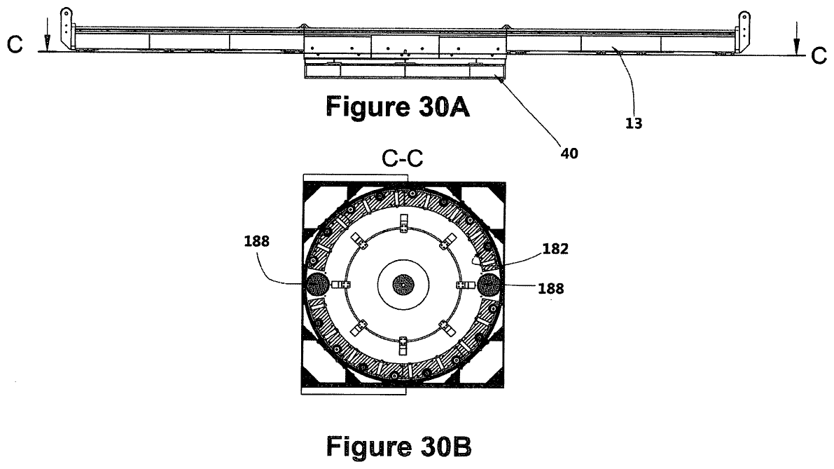

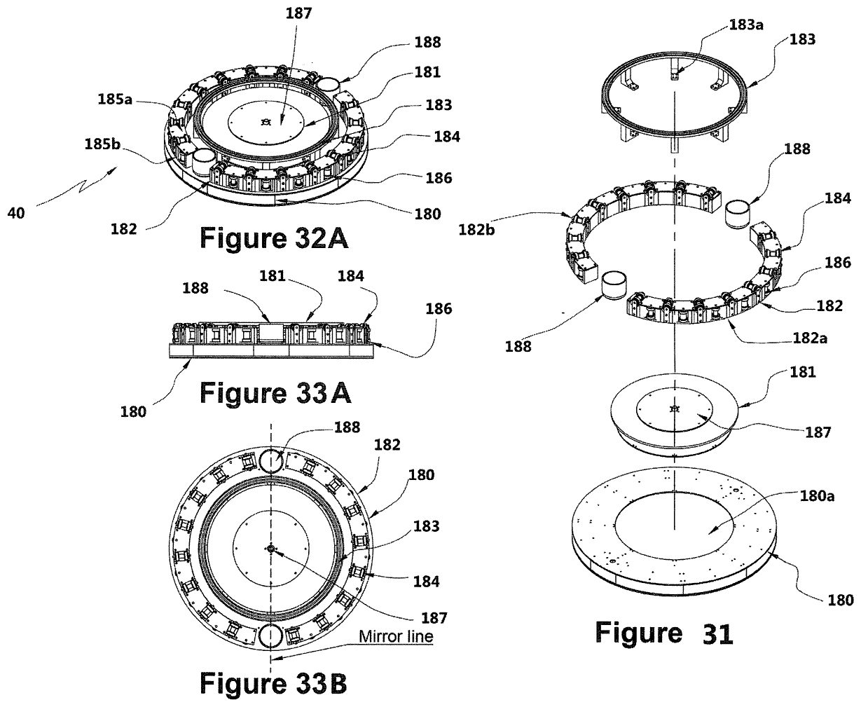

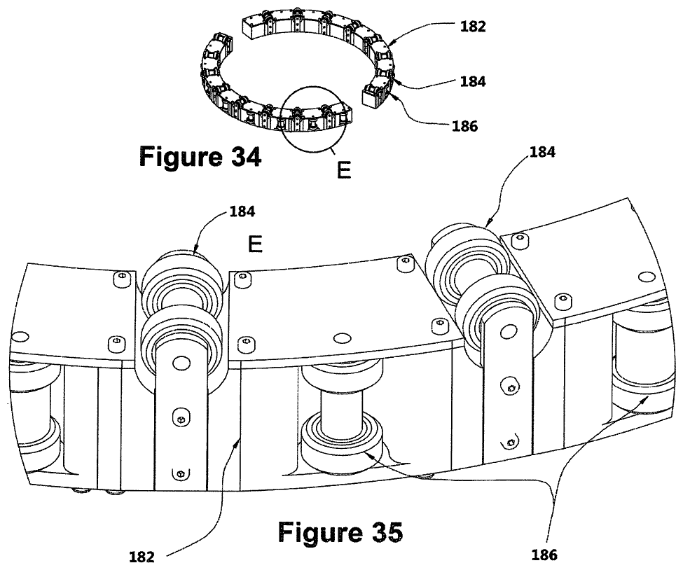

Turning now to the platform 13 and base 40, the spinning movement of the platform 13 to rotate the tracks and passenger cart will now be described. In general, the base forms the foundation of the device and the flywheel cancels the rotational force to the base. This adds to the stability of the device and contributes to the self-standing advantage of the device, i.e., it does not need to be mounted to the ground or other support surface. With reference to FIGS. 26A-35, the platform 13, which has the passenger track 130 and counter track 140 mounted thereon, is designed to spin about its central axis L. Supports 13c, which can be in the form of struts, are attached by bolts, rivets or other fasteners in the square shaped pattern shown in FIG. 26B, on opposite sides of the base 30, provide structural support to the platform 13. The angled struts 13c are shown attached to transverse struts 13d and the track supports at opposing ends. (Only a few of the struts 13c are labeled in the drawings for clarity). Note a different number and/or arrangement of the struts, or other supporting elements, can be provided other than that shown to help add structural support and stability to the platform 13.

Note the platform 13 and base 40 are preferably symmetrical as represented by the mirror line of FIG. 26A.

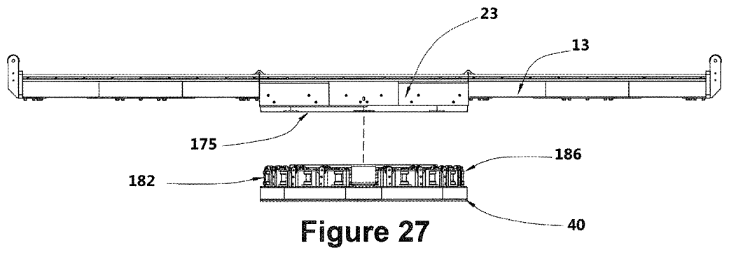

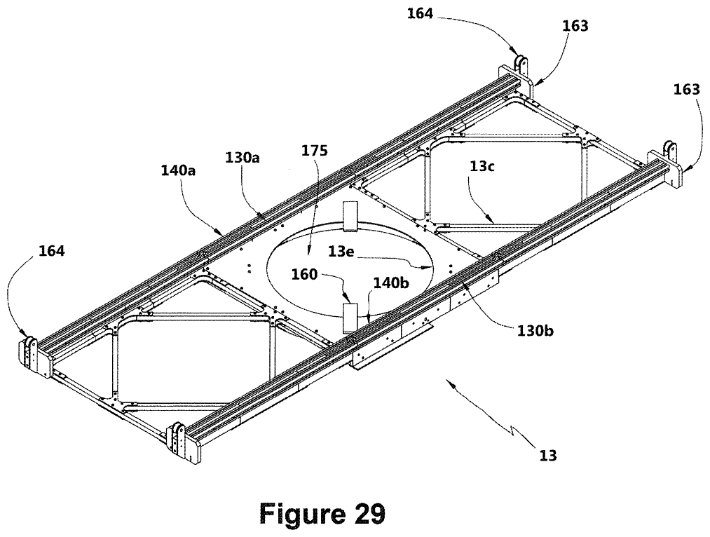

With reference to FIGS. 27 and 31-33B, opening 175 in a central base receiving portion 23 of platform 13 receives the base 40. Base 40 supports the flywheel 180 and roller bearing mount 182. The roller bearing mount 182 has a series of side (sideways) idlers/roller bearings 186 and a series of upper (top) idlers/roller bearings 184 (only a few are labeled for clarity), arranged along the two arcs forming the bearing mount 182 to help reduce friction during spinning. As shown in the drawings, the bearing mount 182 can be in the form of two semicircular portions 182a, 182b, with a drive motor 188 between the two portions 182a, 182b on both sides. Note a different number of side roller bearings and top roller bearings can also be utilized. Idlers 184 extend slightly upwardly beyond the upper surface 185a surface and idlers 186 extend slightly beyond side surface 185b. Side bearings 186 engage the inside wall 13e (FIG. 29) of the rotating platform 13 as the roller bearing mount 182 is positioned in the platform opening 175 and the platform drive motors 188 spin the platform 13 with respect to the stationary base. Top roller bearings 184 engage a bottom surface of the rotating platform 13. The drive motors 188 are actuated to rotate the platform 13 about transverse axis L in the direction of the arrow P in FIG. 6. In preferred embodiments, the platform 13 would rotate/spin only in one direction, e.g., clockwise or counterclockwise, however, it is also envisioned that the assembly can be configured to reverse and rotate/spin the platform 13 in both a clockwise and counterclockwise rotation.

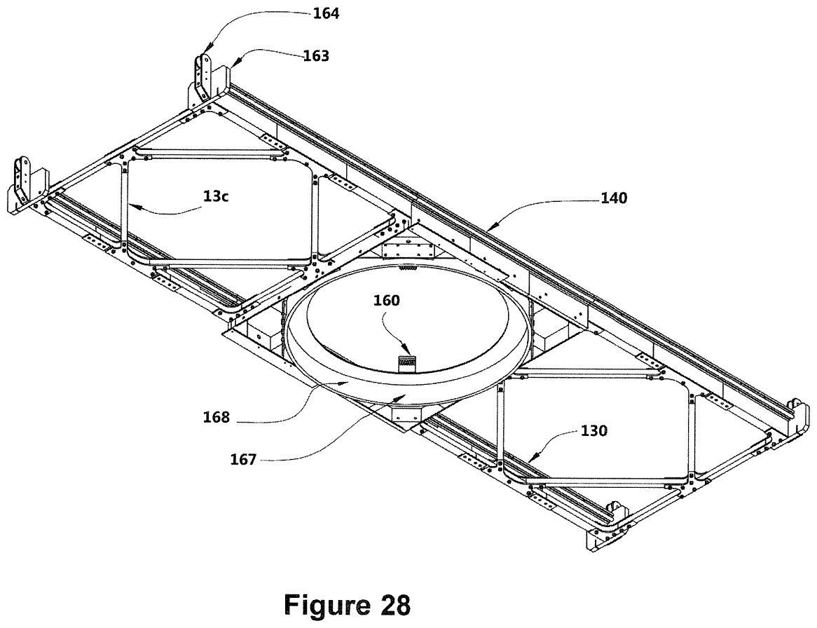

The flywheel 180 is mounted to flywheel hub 181. A motor 187, such as a 3 Phase AC motor, is positioned within an opening 180a of the flywheel 180, with the motor shaft extending through an opening in the flywheel hub 181, and is used to accelerate/decelerate the flywheel 180 (decelerating the flywheel generates electricity used to spin the rotating platform 13, i.e., power the platform driving motors). Slip ring 183 is attached to the flywheel 180 via clips 183a for transmission of power from the motor 187 to the rotating flywheel 180. Stationary slip ring brush 160, shown in FIGS. 28 and 29, is in contact with the slip ring 183. The motor/flywheel/bearing assembly of FIG. 31 is mounted within the base 40.

The rotating platform drive motors 188 make contact with a ring 167 underneath the rotating track 168 to propel them. The ring acts like an infinite road for the rotating platform drive motors 188 to drive on. Platform drive motor 188 and ring 167 behave like the gears in a planetary gear configuration. Instead of gear teeth, rubber tire material is utilized for the friction. The rubber material also makes less noise than teeth.

As the platform 13 starts to spin upon actuation the drive motors 188, the flywheel 180 is: spinning in the same direction. The flywheel 180 forces are applied directly to the base 40 which makes contact with the ground. Thus, the flywheel 180 applies a canceling force to the force applied to the base 40. The result is a net zero force applied to the ground. Thus, the flywheel 180 serves a dual function; stores energy and cancels momentum. It also aids to reduce the electrical load, i.e., peak loads.

In use, before the rotating platform 13 starts spinning, the flywheel 180, powered by motor 187, is slowly sped up. It is slowly sped up to avoid a significant moment of inertia from being transferred to the ground on which the motion simulator 10 lays. When the flywheel 180 is up to speed, it is then slowed down so when the rotating platform 13 starts spinning, the platform's inertia is canceled by the flywheel 180 slowing down. Stated another way, the rotating moment of inertia of the rotating platform 13 is canceled by the inertia of the rotating flywheel 180 slowing down in the opposite direction. If the platform 13 is spinning clockwise, the flywheel 180 will spin counterclockwise. When the platform 13 is accelerated clockwise, it will cause a counterclockwise moment. The already spinning counterclockwise flywheel 180 will slow down producing a counterclockwise moment. The flywheel/platform will produce a moment in the direction it is slowing down. If the platform is decelerating clockwise causing a clockwise moment, the flywheel will speed up clockwise causing a counterclockwise moment. The slowing platform's energy will be used to accelerate the flywheel. The momentum of each rotating mass will be exchanged through electricity. The energy losses will be made up for with a constant current coming from the grid. The slowing flywheel 180 is used to generate electricity to spin the rotating platform 13 in the opposite direction so the motion simulator 10 will need little or no excess energy from the grid. That is, the motion simulator requires constant current from the grid, but unlike other simulators, there is less peak loading as massive peaks are not provided as the flywheel generates power, stores anergy and applies energy to motors 188 to spin the platform 13 on the stationary base.

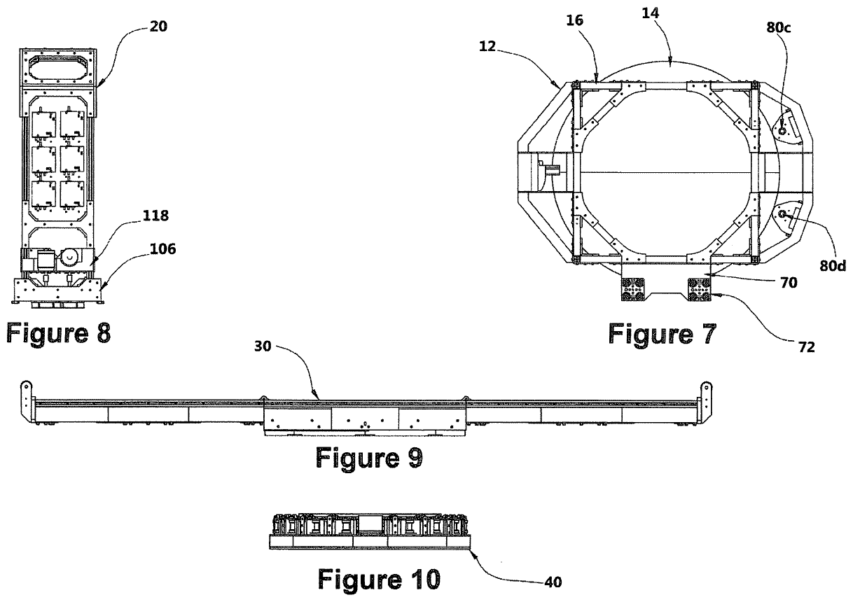

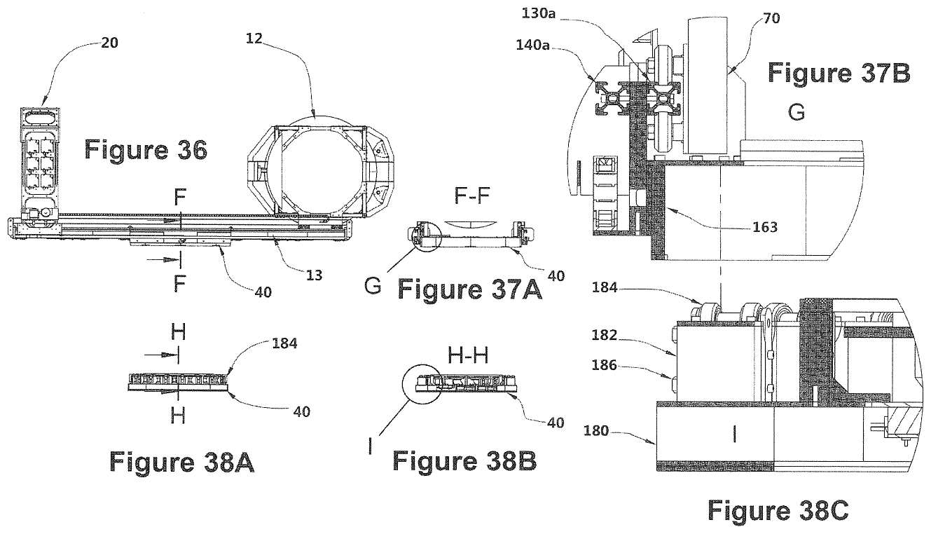

FIGS. 39A-43 illustrate an alternate embodiment of the motion simulator of the present invention wherein the simulator is foldable. The simulator device is designated generally by reference numeral 10′ and is identical to the motion simulator 10 of FIG. 1 except for the foldability feature. Since besides the foldability, device 10′ is the same as device 10, e.g., the passenger cart 12, counter cart 20, rotating platform 13, base 40, etc., are the same, further discussion of these components and their function for brevity are not repeated herein, it being understood that the discussion herein of the components and function of the device 10 are fully applicable to device 10′. The components in FIGS. 39A-43 that are the same as those of device 10 of FIGS. 1-38C are labeled with the same reference numerals.

More specifically, device 10′ differs from device 10 in that the platform is divided into three sections: first end section 31a, second end section 31b and middle section 31c interposed between end sections 31a and 31b. Sections 31a, 31b are preferably of the same length, although other lengths are contemplated. The middle section 31c can have the same length as one or both of end sections 31a, 31b or be of different length. In the embodiment illustrated in FIG. 39A, middle section 31b has a length less than the length of end sections 31a, 31b.

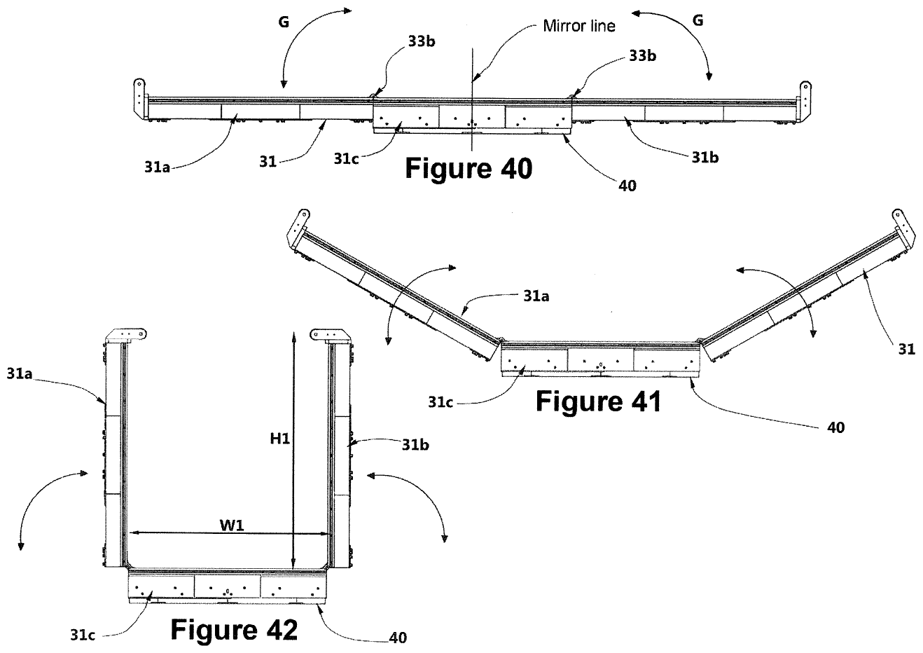

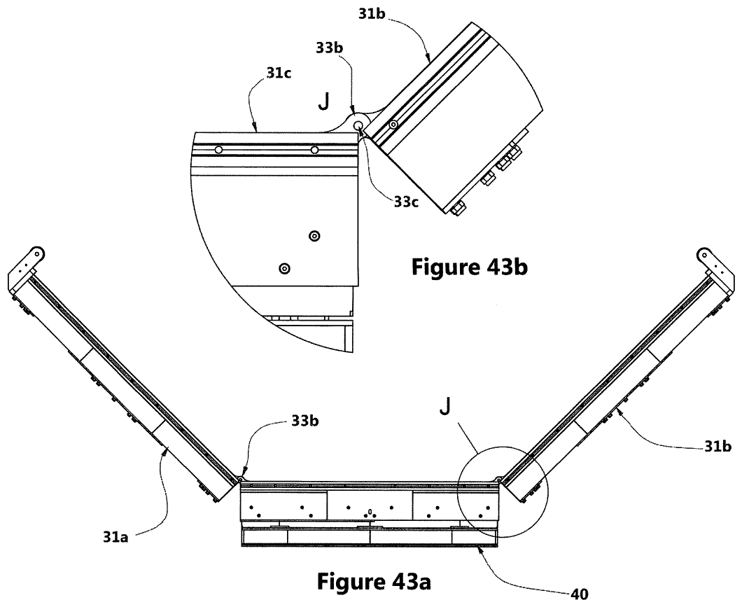

End section 31a is hingedly attached to one end of middle section 31c and end section 31b is hingedly attached to the opposite end of middle section 31c. As shown in the close up view of FIG. 43B, pin 33c extends through connector 33b which connects the two sections 31b, 31c. The same connector 33b/pin 33c connects middle section 31c and end section 31a. In this way, end sections 31a, 31b can pivot upwardly with respect to the middle section 31c to move to the folded position. Other types of connections to enable pivotal movement of the end sections can alternatively be utilized. In some embodiments, the device 10′ can include a latch or other mechanism to maintain the end sections 31a and 31b in the upright folded position of FIG. 39B and/or in the open (linear) position of FIG. 40. In other embodiments, the hinge provides an over center lock so that once the end sections 31a, 31b are pivoted to a certain degree, they do not return to their initial linear position of FIG. 40 until a sufficient force is applied to the end sections 31a, 31b. (Note FIG. 26A and a few other Figures show connector 33c to illustrate its location, it being understood that these Figures depict a device that does not necessarily have the foldability feature, although it can be adapted to have such feature).

The foldability feature of the motion simulator 10′ can be appreciated by a comparison of FIGS. 40-42. In FIG. 40, the platform 31 is in the fully open position wherein the three sections 31a, 31b and 31c are in linear alignment. This corresponds to the in-use position. In FIG. 41 (and FIG. 39A), the end sections 31a, 31b are partially pivoted in the direction of the arrow G to show the partially folded position. In FIG. 42 (and FIG. 39B), the end sections 31a, 31b are in the fully pivoted position such that end sections 31a, 31b are substantially perpendicular to the middle section 31c. This corresponds to the storage and/or transport position. In this position, the motion simulator 10′ can be easily transported, e.g., can be transported on a flatbed truck. Further, in this position, the motion simulator 10′ occupies less storage space.

As shown in FIG. 39B, in the fully folded position, the end sections 31a, 31b openings accommodate the portions of the passenger pod 14 and/or portions of the frame 12 that extend therethrough. Note that in order to fold the device 10′, the passenger cart 12 and counter cart 20 are first moved from an outer position to an inner position, preferably to the center of the device 10 onto the tracks of the middle section 31c. As discussed above, the counter cart frame 22 is configured so that it can receive the passenger cart 12 therein to thereby conserve space as shown in FIG. 39B. FIG. 42 shows the height H1 and width W1 between end sections 31a, 31b which are dimensioned to accommodate passenger cart 12 and counter cart 20.

Sensors can be provided to detect various parameters of the foregoing embodiments of the system as well as various parameters of the passenger during use of the motion simulator. Adjustments can be made during use in response to feedback from such sensors and analysis of the data. Feedback can be visual, haptic, verbal, etc. Adjustments can also be made post use to adapt for future use of the motion simulator. The sensors in some embodiments can send a signal to the control to automatically activate the controls to effect a change without any action from the user or individual outside the passenger pod (external personnel), or alternatively, the sensors can send a signal to the user (passenger) or to an individual or third party outside the passenger pod so the passenger or outside individual can effect a change. Changes can include a change in movement of the passenger cart, change in movement of the passenger pod, change of the viewing screens, etc.

The sensors can also be configured to activate automatic adjustments of the motion, speed, direction, etc. during use if certain parameters are not met or certain parameters are exceeded.

External controls can include a graphic display to display various parameters and external devices can collect and store data for in use or later evaluation or for data collection for evaluation of data from multiple users.

AI based learning is also contemplated.

The motion simulator of the present invention is perfectly balanced so it does not need to be attached to the ground. Essentially, if it fits an area/location it can merely be placed and sit in that area. Thus, it generates and exposes passengers to realistic dynamic omni-directional G-Forces without requiring fixation to the ground or support.

Although the apparatus and methods of the subject invention have been described with respect to preferred embodiments, those skilled in the art will readily appreciate that changes and modifications may be made thereto without departing from the spirit and scope of the present invention as defined by the appended claims. Persons skilled in the art will understand that the various embodiments of the disclosure described herein and shown in the accompanying figures constitute non-limiting examples, and that additional components and features may be added to any of the embodiments discussed herein without departing from the scope of the present disclosure.

It will be understood by those skilled in the art that the above particular embodiments are shown and described by way of illustration only. The principles and the features of the present disclosure may be employed in various and numerous embodiments thereof without departing from the scope and spirit of the disclosure as claimed. The above-described embodiments do not restrict the scope of the disclosure.

Additionally, persons skilled in the art will understand that the elements and features shown or described in connection with one embodiment may be combined with those of another embodiment without departing from the scope of the present invention and will appreciate further features and advantages of the presently disclosed subject matter based on the description provided.

Throughout the present disclosure, terms such as “approximately,” “about”, “generally,” “substantially,” and the like should be understood to allow for variations in any numerical range or concept with which they are associated. It is intended that the use of terms such as “approximately”, “about”, “substantially”, and “generally” should be understood to encompass variations on the order of 25%, or to allow for manufacturing tolerances and/or deviations in design.

The recitation of numerical ranges by endpoints includes all numbers within the range.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present invention.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

1. A motion simulator comprising:
a first track;
a second track;
a first cart having a compartment configured to receive a passenger, the first cart movable linearly along the first track; and
a second cart, the second cart movable along the second track, the second cart providing a counter to the first cart.

2. (canceled)

3. The motion simulator of claim 1, wherein the second cart provides a counterforce and a counterbalance to a mass of the first cart and the second cart moves linearly in conjunction with linear movement of the first cart.

4. The motion simulator of claim 1, wherein the first cart is pivotable about an axis transverse to a longitudinal axis of the first track.

5. The motion simulator of claim 1, wherein the first cart comprises a first frame supporting a pod, the pod containing the compartment, and the second cart includes a second frame dimensioned to receive the first frame within the second frame.

6. (canceled)

7. The motion simulator of claim 5, further comprising a plurality of omnidirectional wheels engageable with the pod to effect angular movement of the pod in one or more of left, right, upward and downward directions.

8. The motion simulator of claim 7, wherein the omnidirectional wheels are in constant contact with an outer surface of the pod to support opposing sides of the first cart to maintain stability of the pod during directional movement.

9-11. (canceled)

12. The motion simulator of claim 1, further comprising a platform which supports the first and second tracks and the first and second carts, the platform spinnable about a central axis to move the first cart along an arc in a full circular rotational movement.

13. The motion simulator of claim 12, further comprising a base supporting the platform, wherein the base includes a flywheel to cancel rotational forces to the base to provide stability to the motion simulator.

14. The motion simulator of claim 1, wherein the first and second tracks are foldable to provide compactness for transport.

15-19. (canceled)

20. The motion simulator of claim 18, further comprising a first motor assembly and first pulley assembly for effecting linear movement of the first cart and a second motor assembly and second pulley assembly for effecting linear movement of the second cart.

21-22. (canceled)

23. A motion simulator comprising:
a base;
a platform supported by the base;
a passenger cart supported by the platform, the passenger cart having a compartment configured to receive a passenger, the passenger cart movable linearly along a first track, the platform spinnable about a central axis to move the passenger cart along an arc in a full circular rotational movement; and
at least a first motor actuable to move the passenger cart linearly;
wherein the motion simulator is self-supporting such that it is operational to spin the platform and move the passenger cart linearly without being mounted to a supporting surface.

24. The motion simulator of claim 23, wherein the passenger is exposed to omni-directional G-forces and a direction of force is changed without a gyroscope.

25. (canceled)

26. The motion simulator of claim 23, wherein the base includes a flywheel to cancel rotational forces to the base to provide stability to the motion simulator.

27. The motion simulator of claim 23, further comprising a second cart movable linearly to counter linear movement of the first cart, wherein the platform supports a second track, the second cart movable linearly along the second track, the passenger cart and second cart linearly movable toward and away from each other.

28-29. (canceled)

30. The motion simulator of claim 23, wherein the passenger cart includes a frame and a pod containing the compartment, and further comprising a plurality of omnidirectional wheels engageable with the pod to effect angular movement of the pod in one or more of left, right, upward and downward directions.

31-42. (canceled)

43. A motion simulator comprising:
a base;
a platform supported by the base;
a passenger cart supported by the platform, the passenger cart having a compartment, the compartment configured to receive a passenger, the passenger cart movable linearly along the first track, the platform spinnable about a central axis to move the passenger cart along an arc in a full circular rotational movement; and
at least a first motor actuable to move the passenger cart linearly;
wherein the base includes a flywheel to cancel rotational forces to the base to provide stability to the motion simulator.

44. The motion simulator of claim 43, wherein the flywheel generates electricity to spin the rotating platform, and the platform is powered by a first motor and the flywheel is powered by a second motor and the flywheel provides power to the first motor.

45-47. (canceled)

48. The motion simulator of claim 43, wherein the platform spins relative to the base which is stationary, wherein the flywheel forces are applied directly to the base which is in contact with a ground or supporting surface.

49. The motion simulator of claim 43, wherein in use the flywheel starts spinning prior to the platform starting to spin, the flywheel spinning slowing when the platform starts spinning.

50. The motion simulator of claim 43, further comprising a second cart to provide a counterbalance to the passenger cart, and second motor assembly and second pulley assembly for effecting linear movement of the second cart toward and away from the passenger cart, wherein the passenger and second cart are movable independently from each other powered by different motor assemblies.

51-55. (canceled)
